(19) United States
(12) Patent Application Publication
(10) Pub. No.: US 2018/0313997 A1
(43) Pub. Date: Nov. 1, 2018

(54) LIGHTING DEVICE AND DISPLAY DEVICE

(71) Applicant: SHARP KABUSHIKI KAISHA, Sakai City, Osaka (JP)

(72) Inventors: MITSUHIRO MURATA, Sakai City (JP); HISASHI WATANABE, Sakai City (JP); HIROTOSHI YASUNAGA, Sakai City (JP); RYUZO YUKI, Sakai City (JP)

(21) Appl. No.: 15/772,084

(22) PCT Filed: Oct. 26, 2016
(86) PCT No.: PCT/JP2016/081673

§ 371 Date: Apr. 29, 2018

(30) Foreign Application Priority Data
Nov. 2, 2015 (JP) 2015-215835

(51) Int. Cl. F21V 8/00; G02F 1/1335

(52) U.S. Cl. CPC G02B 6/0031; G02F 1/133603; G02B 6/0025; G02F 1/133512; G02F 1/133514

(57) ABSTRACT

A backlight unit includes LEDs, a light guide plate, and a hood-shaped reflection member. The LEDs are linearly arranged at intervals. The light guide plate includes a light entering end surface and a light exiting plate surface. The light entering end surface is at least a part of the peripheral end surfaces extending along an arrangement direction of the LEDs and opposed to light emitting surfaces of the LEDs. The hood-shaped reflection member surrounds inter-LED spaces between adjacent LEDs and includes an opening a light guide plate side. The hood-shaped reflection member includes at least a first reflection portion and a pair of second reflection portions. The first reflection portion is opposed to the light entering end surface 15a. The second reflection portions are separated from each other in a thickness direction of the light guide plate such that the inter-LED spaces LS are between the second reflection portions.

### TECHNICAL FIELD

The present invention relates to a lighting device and a display device.

### BACKGROUND ART

A backlight used in a known liquid crystal display device that is described in Patent Document 1 has been known as one example. A planar lighting device that is a backlight described in Patent Document 1 includes LEDs on the FPC closer to one edge thereof and black light blocking material is printed on the FPC to surround the LEDs. A white double-sided adhesive tape is formed into a shape the same as the area of the FPC overlapping the light guide plate and then shaped to include a cutout. The cutout is formed in a section corresponding to the LEDs mounted on the FPC and in front of the front surfaces of the LEDs. The FPC is bonded to the light guide plate with the white double-sided adhesive tape. Light that is directed to the FPC is blocked by the light blocking material printed on the white double-sided adhesive tape and the FPC to reduce reflection of a color of the FPC. Brightness of the front side area of the LEDs is adjusted by changing an area ratio of an area of the block light blocking member exposed via the cutout to an area of the white double-adhesive tape and thus to reduce the unevenness in brightness.

### RELATED ART DOCUMENT

### Patent Document

Patent Document 1: Japanese Unexamined Patent

### Problem to be Solved by the Invention

In the planar lighting device described in Patent Document 1, a certain amount of rays of light from the LEDs is absorbed by the black light blocking member to adjust the brightness of the front side area of the LEDs. Therefore, use efficiency of the light rays emitted by the LEDs may be lowered and the brightness of the exit light rays from the light guide plate may be lowered. The amount of light rays entering through the entrance surface of the light guide plate through which the light rays from the LEDs enters is likely to be different in sections opposite the LEDs and sections between the adjacent LEDs. The uneven brightness may occur in exiting light within a surface of the light guide plate.

### DISCLOSURE OF THE PRESENT INVENTION

An object of the present invention is to restrict unevenness and a reduction in brightness.

### Means for Solving the Problem

A lighting device according to the present invention includes light sources, a light guide plate, and a hood-shaped reflection member. The light sources are linearly arranged at intervals. The light guide plate has a flat plate shape. The light guide plate includes a light entering end surface and a light exiting plate surface through which light rays exit. The light entering end surface extends along an arrangement direction of the light sources. The light entering end surface is at least a part of a peripheral end surface of the light guide plate opposed to light emitting surfaces of the light sources. The light exiting plate surface is one of plate surfaces of the light guide plate. The hoods-shaped reflection member surrounds at least an inter-light source space between the adjacent light sources and includes an opening on a light guide plate side. The hood-shaped reflection member includes at least a first reflection portion and a pair of second reflection portions. The first reflection portion is opposed to the light entering end surface. The second reflection portions are continuous from the first reflection portion to be separated from each other in a thickness direction of the light guide plate such that the inter-light source space is between the second reflection portions.

According to such a configuration, the light rays emitted by the light sources linearly arranged at intervals and exiting through the light emitting surfaces enter the light guide plate having the flat plate shape through the light entering end surface, travel through the light guide plate, and exit through the light exiting plate surface. The light entering end surface is a part of the peripheral end surface of the light guide plate opposed to the light emitting surfaces. The light exiting plate surface is one of the plate surfaces of the light guide plate. An amount of the light rays entering the light entering end surface tends to be relatively high in areas directly opposite the light sources but relatively low in an area directly opposite the inter-light source space between the adjacent light sources. A difference in the amount of the light rays may result in uneven brightness of light exiting through the light exiting plate surface. In this lighting device, the hood-shaped reflection member includes at least the first reflection portion and the second reflection portion. The first reflection portion surrounds at least the light sources and includes the opening at least on the light guide plate side. The first reflection portion is opposed to the light entering end surface. The second reflection portions are continuous from the first reflection portion and separated from each other in the thickness direction of the light guide plate such that the inter-light source space is between the second reflection portions. According to the configuration, the light rays in the inter-light source space from the light sources may be reflected by the first reflection portions and the second reflection portions. The reflected light rays may be mixed together and efficiently directed toward the light entering end surface through the opening of the hood-shaped reflection member. The light rays exiting through the opening of the hood-shaped reflection member mainly enter the area of the light entering end surface directly opposite the inter-light source space. Therefore, the difference in the amount of the light rays between the areas of the light entering end surface directly opposite the light sources and the area of the light entering end surface directly opposite the inter-light source space can be reduced. According to the configuration, the uneven brightness is less likely to occur in the light exiting through the light exiting plate surface. According to the hood-shaped reflection member, the reflected light rays in the inter-light source space are mixed and thus the uneven brightness is reduced. In comparison to the conventional configuration in which the light rays are absorbed to reduce the uneven brightness, the reduction in brightness is less likely to occur.

Following configurations may be preferable for embodiments of the present technology.

(1) The first reflection portion and the second reflection portions of the hood-shaped reflection member may extend along the arrangement direction of the light sources to be opposed to at least one of the light source. Because the light sources on the sides of the inter-light source space are surrounded by the first reflection portion and the second reflection portions of the hood-shaped reflection member, higher light use efficiency can be achieved. This configuration is more preferable for restricting the reduction in brightness. Furthermore, installation and production of the hood-shaped reflection member can be simplified.

(2) The first reflection portion and the second reflection portions of the hood-shaped reflection member may extend along the arrangement direction of the light sources to be opposed to all the light sources. Because the light sources and the inter-light source space are collectively surrounded by the first reflection portion and the second reflection portions of the hood-shaped reflection member, further higher light use efficiency can be achieved. This configuration is further preferable for restricting the reduction in brightness.

(3) One of the second reflection portions of the hood-shaped reflection member disposed on a light exiting plate surface side relative to the inter-light source space with respect to the thickness direction may be located on a plane on which the light emitting surfaces of the light sources are located. According to the configuration, the reflected light rays may be sufficiently mixed together in the inter-light source space and sufficiently high light use efficiency can be achieved. Even if the frame width of the lighting device is reduced, the hood-shaped reflection member is less likely to be recognized by a user of the lighting device.

(4) The lighting device may further include a light source board on which the plurality of light sources may be mounted. The hood-shaped reflection member may include a light source board overlapping portion disposed to overlap the light source board on a mounting side on which the light sources may be mounted and configured as any one of the first reflection portion and the second reflection portion. The light source board overlapping portion may include light source insertion through holes in which the light sources may be inserted. Because the light source board overlapping portion of the hood-shaped reflection member may be disposed to overlap the light source board on the mounting side on which the light sources are mounted and configured as any one of the first reflection portion and the second reflection portions, the light rays in the inter-light source space can be efficiently reflected an directed toward the light entering end surface of the light guide plate. Furthermore, the light sources are inserted in the light source insertion through holes formed in the light source board overlapping portion that is disposed as described above.

(5) The light sources may include terminals connected to the light source board, respectively. The hood-shaped reflection member may be made of metal having conductivity and include insulators on a surface opposed to the light source board at positions overlapping the terminals. Because the insulators may be disposed on the surface opposed to the light source board at the positions overlapping the terminals of the light sources, the terminals of the light sources are less likely to directly contact the hood-shaped reflection member even if the hood-shaped reflection member disposed to overlap the light source board is made of metal having conductivity. Therefore, a short circuit is less likely to be developed.

(6) The light source board overlapping portion of the hood-shaped reflection member may be configured as any one of the second reflection portions. This configuration is preferable when a light source board on which side emitting type light sources are mounted is used.

(7) The light source board overlapping portion of the hood-shaped reflection member may be configured as the first reflection portion. This configuration is preferable when a light source board on which top emitting type light sources are mounted is used.

(8) The lighting device may further include a board holding member disposed such that the light source board may be sandwiched between the light source board overlapping portion and the board holding member. According to this configuration, the light source board can be held by the board holding member.

(9) The lighting device may further include a light guide plate reflection member disposed to overlap an opposite plate surface of the light guide plate on an opposite side from the light exiting plate surface and configured to reflect the light rays. The hood-shaped reflection member may be integrated with the light guide plate reflection member. According to the configuration, the light rays traveling in the light guide plate can be reflected toward the light exiting plate surface by the light guide plate reflection member. Because the hood-shaped reflection member may be integrated with the light guide plate reflection member, the hood-shaped reflection member may have high light reflectivity at the same level as light reflectivity of the light guide plate reflection member. Furthermore, the number of parts and the number of assembly steps can be reduced and thus a cost related to installation of the hood-shaped reflection member can be reduced.

(10) The lighting device may further include a light guide plate reflection member and a holding member. The light guide plate reflection member may be disposed to overlap an opposite plate surface of the light guide plate on an opposite side from the light exiting plate surface and configured to reflect the light rays. The holding member may be disposed to overlap the light guide plate reflection member on an opposite side from the light guide plate side to sandwich the light guide plate reflection member with the light guide plate. The hood-shaped reflection member may be integrated with the holding member. According to the configuration, the light rays traveling in the light guide plate can be reflected toward the light exiting plate surface by the light guide plate reflection member. Because the light guide plate reflection member may be sandwiched between the light guide plate and the holding member, the light guide plate reflection member may have high shape stability. Therefore, the light rays can be properly directed toward the light exiting plate surface by the light guide plate reflection member. Because the holding member and the hood-shaped reflection member may be provided as a single component, the number of parts and the number of assembly steps can be reduced and thus a cost related to installation of the hood-shaped reflection member can be reduced,

(11) The hood-shaped reflection member may be made of synthetic resin. Reflection films may be formed on the first reflection portion and the second reflection portions of the hood-shaped reflection member, respectively. In such a configuration in which the hood-shaped reflection member may be made of synthetic resin, a sufficient level of light reflectivity may not be achieved at the surface of the hood-shaped reflection member. With the reflection films formed on the first reflection portion and the second reflection portions, the hood-shaped reflection member can have sufficiently high light reflectivity.

(12) The hood-shaped reflection member may include a pair of side reflection portions covering the light sources at ends with respect to the arrangement direction of the light sources from outer sides with respect to the arrangement direction, respectively. According to the configuration, the light rays emitted by the light sources at the ends with respect to the arrangement direction can be reflected toward the light entering end surface by the side reflection portions. Because the light rays are less likely to leak to outer sides with respect to the arrangement direction. Therefore, higher light use efficiency can be achieved.

To solve the problem described earlier, a display device according to the present invention includes the lighting device described above and a display panel configured to display images using light applied by the lighting device. Because the lighting device emits light with brightness, the unevenness and the reduction in which are less likely to occur, the display device having such a configuration can display images with high display quality.

### Advantageous Effect of the Invention

According to the present invention, unevenness and a reduction in brightness are less likely to occur.

### BRIEF DESCRIPTION OF THE DRAWINGS

FIG. 1 is an exploded perspective view illustrating a liquid crystal display device according to a first embodiment of the present invention.

FIG. 2 is a plan view of a backlight unit without an optical sheet.

FIG. 3 is a magnified plan view illustrating an LED and therearound in FIG. 2.

FIG. 4 is a cross-sectional view taken along line iv-iv in FIG. 3.

FIG. 5 is a cross-sectional view taken along line v-v in FIG. 3.

FIG. 6 is a cross-sectional view taken along line vi-vi in FIG. 4.

FIG. 7 is a cross-sectional view illustrating a reflection sheet and the LED board before mounting.

FIG. 8 is a cross-sectional view illustrating the LED board and the reflection sheet that is mounted in the LED board.

FIG. 8 is a plan view illustrating a brightness distribution within a light exiting plate surface of a light guide plate according to a comparative example of a comparative experiment.

FIG. 9 is a plan view illustrating a brightness distribution within a light exiting plate surface of a light guide plate according to a comparative example of a comparative experiment.

FIG. 10 is a plan view of a brightness distribution within a light exiting plate surface of a light guide plate according to an example of a comparative experiment.

FIG. 11 is a side cross-sectional view of a section of a backlight unit including an LED according to a second embodiment of the present invention.

FIG. 12 is a side cross-sectional view of a section of the backlight unit between LEDs.

FIG. 13 is a cross-sectional view taken along line xiii-xiii in FIG. 11.

FIG. 14 is a side cross-sectional view illustrating an LED board and a holding member with a hood-shaped reflection member before mounting.

FIG. 15 is a side cross-sectional view taken along line xiii-xiii in FIG. 11 before the hood-shaped reflection member is mounted to the LED board.

FIG. 16 is a side cross-sectional view illustrating a section of a backlight unit including an LED according to a third embodiment of the present invention.

FIG. 17 is a side cross-sectional view illustrating a section of the backlight unit between the LEDs.

FIG. 18 is a cross-sectional view illustrating components before a side member and a bottom member with the hood-shaped reflection member are mounted to the LED board.

FIG. 19 is a side cross-sectional view of a section of a backlight unit including an LED according to a fourth embodiment of the present invention.

FIG. 20 is a side cross-sectional view of a section of the backlight unit between LEDs.

FIG. 21 is a side cross-sectional view illustrating an LED board before a reflection sheet with a hood-shaped reflection member is mounted.

FIG. 22 is a side cross-sectional view of a section of a backlight unit including an LED according to a fifth embodiment of the present invention.

FIG. 23 is a side cross-sectional view of a section of the backlight unit between LEDs.

FIG. 24 is a side cross-sectional view of a section of a backlight unit including an LED according to a sixth embodiment of the present invention.

FIG. 25 is a side cross-sectional view of a section of the backlight unit between LEDs.

FIG. 26 is a side cross-sectional view before mounting of an LED board, a hood-shaped reflection member, and a casing.

FIG. 27 is a plan cross-sectional view of a backlight unit according to a seventh embodiment of the present invention.

FIG. 28 is a side cross-sectional view of a section of a backlight unit including an ELD according to an eighth embodiment of the present invention.

### MODES FOR CARRYING OUT THE INVENTION

### First Embodiment

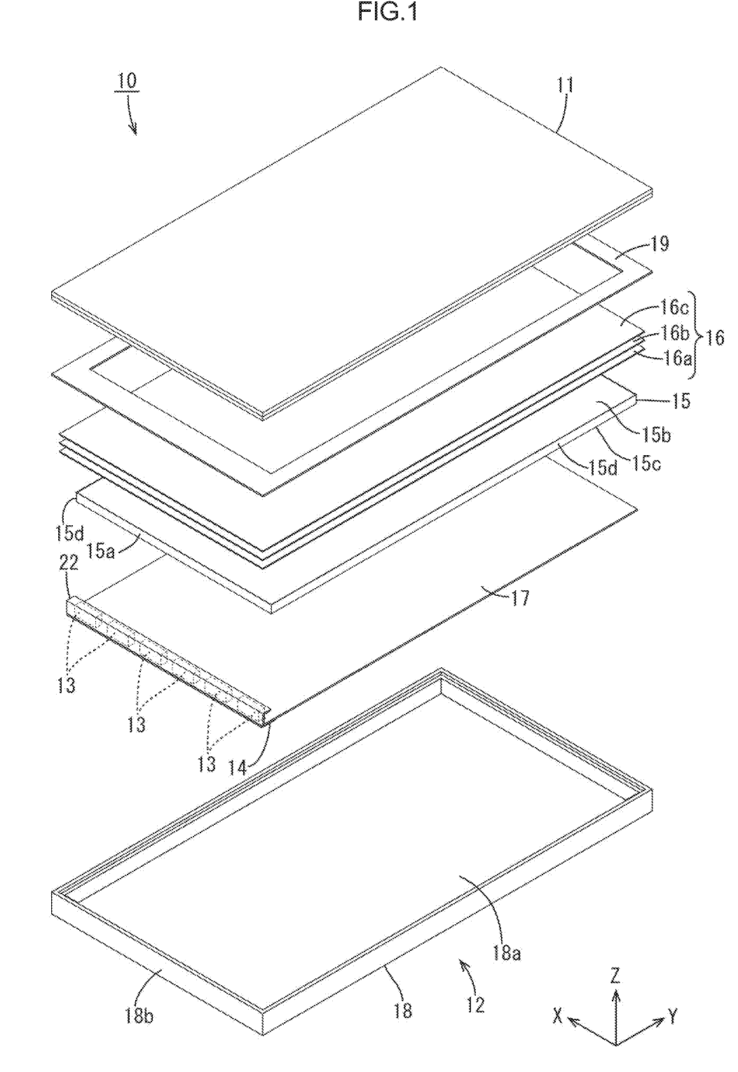

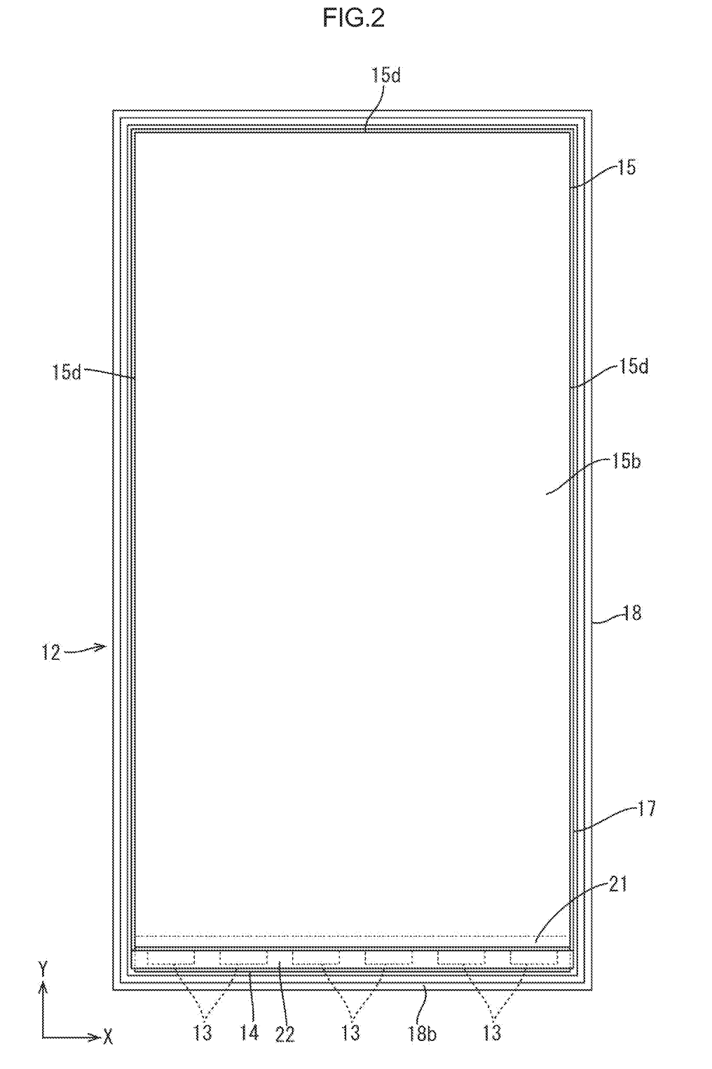

A first embodiment of the present invention will be described with reference to FIGS. 1 to 10. In this section, a liquid crystal display device 10 (a display device) including a liquid crystal panel 11 as a display panel will be described as an example. X-axes, Y-axes and Z-axes may be present in the drawings. The axes in each drawing correspond to the respective axes in other drawings to indicate the respective directions. Upper sides and lower sides in in FIG. 2 correspond to a front side and a rear side of the liquid crystal panel 11, respectively.

As illustrated in FIG. 1, the liquid crystal display device 10 has a rectangular shape as a whole and includes the liquid crystal panel 11 (a display panel) configured to display images and a backlight unit 12 (a lighting device) disposed behind the liquid crystal panel 11. The backlight unit 12 is an external light source configured to supply light to the liquid crystal panel 11. A frame-shaped bezel, which is not illustrated, may be arranged on the front side of the liquid crystal panel 11 such that a peripheral portion of the liquid crystal panel 11 (a non-display area which will be described later) is held between the bezel and the backlight unit 12. The liquid crystal panel 11 may be covered with a touch panel or a cover panel, which are not illustrated, from the front side. The liquid crystal display device 10 according to this embodiment is used in portable electronic devices such as smart phones and tablet-type laptop computers, and the display size is approximately from four inches to twenty inches.

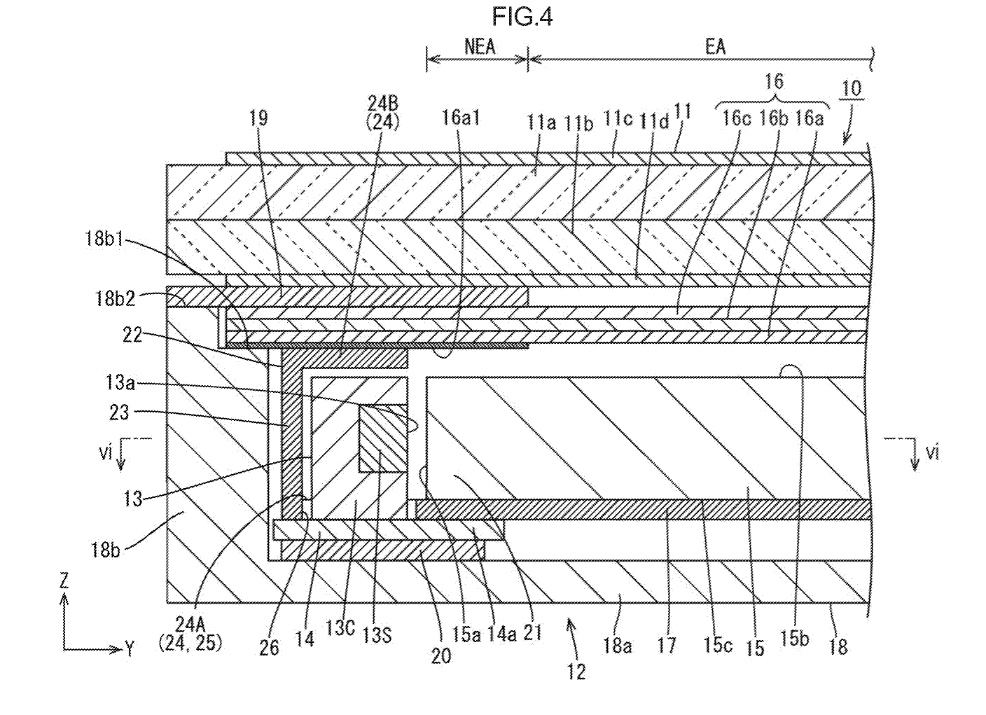

The liquid crystal panel 11 will be described in detail. The liquid crystal panel 11 has a rectangular overall shape in a plan view. As illustrated in FIGS. 1 and 4, the liquid crystal panel 11 includes a pair of substantially transparent glass substrates 11a and 11b having high light transmissivity and a liquid crystal layer (not illustrated) disposed between the glass substrates 11a and 11b. The liquid crystal layer contains liquid crystal molecules having optical characteristics that change according to application of an electric field. The substrates 11a and 11b are separated from each other with a gap corresponding to a thickness of the liquid crystal layer and bonded with a sealing agent, which is not illustrated. A display surface of the liquid crystal panel 11 is sectioned into a display area (an active area) and a non-display area (a non-active area) formed in a frame shape to surround the display area. The images are displayed in the display area but not displayed in the non-display area. One of the glass substrates 11a and 11b included in the liquid crystal panel 11 on the front (a front surface side) is a CF substrate 11a and another one on the rear (a rear surface side) is an array substrate 11b. A flexible circuit board (not illustrated) includes a first end connected to a signal source (such as a control board, which is not illustrated) and a second end connected to the array substrate 11b. Accordingly, various signals are supplied from the signal source to the array substrate 11b. Polarizing plates 11c and 11d are bonded to outer surfaces of the substrates 11a and 11b, respectively. In the liquid crystal panel 11, a short direction corresponds with the Y-axis direction, a long direction corresponds with the X-axis direction, and a thickness direction corresponds with the Z-axis direction.

An internal configuration of the liquid crystal panel 11 in the display area (not illustrated) will be described. On an inner surface of the array substrate 11b (on a surface close to the liquid crystal layer, on a surface opposite the CF substrate 11a), switching components such as thin film transistors (TFTs) and pixel electrodes are arranged in a matrix. Gate lines and source lines that form a grid are arranged to surround the TFTs and the pixel electrodes. Signals relating images are supplied to the gate lines and the source lines from the signal supply source. Each pixel electrode that is disposed in a square area defined by the gate lines and the source lines is formed of a transparent electrode such as indium tin oxide (ITO) or zinc oxide (ZnO). Color filters are arranged on the CF substrate 11a corresponding to the pixels. The color filters include three colors of red (R), green (G), blue (B) that are repeatedly arranged. A light blocking layer (a black matrix) is disposed among the coloring filters such that color mixture is less likely to occur. A common electrode is disposed on surfaces of the color filters and the light blocking layer to be opposite the pixel electrodes on the array substrate 11b. The CF substrate 11a is slightly smaller than the array substrate 11b. Alignment films are disposed on inner surfaces of the substrates 11a and 11b, respectively, to orientate the liquid crystal molecules contained in the liquid crystal layer.

Next, a configuration of the backlight unit 12 will be described in detail. The backlight unit 12 has a substantially rectangular block shape in a plan view as a whole similar to that of the liquid crystal panel 11. As illustrated in FIG. 1, the backlight unit 12 includes at least the LEDs (light emitting diodes) 13 as a light source, an LED board 14 (a light source board) on which the LEDs 13 are mounted, a light guide plate 15 that guides light rays from the LEDs 13, an optical sheet 16 (an optical member) which is disposed on the front side of the light guide plate 15, a reflection sheet 17 (a light guide plate refection member) disposed on the rear side of the light guide plate 15, and a casing 18 (a housing member) which collectively holds the light guide plate 15 and the optical sheet 16 therein. The backlight unit 12 includes the LEDs 13 (the LED board 14) at one of long edges of the backlight unit 12 and the liquid crystal panel 11. Thus, the backlight unit 12 of this embodiment is an edge light type (a side-light type) backlight unit of one-side light entering type in which light from the LEDs 13 enter the light guide plate 15 through only one side. Next, components included in the backlight unit 12 will be described in detail.

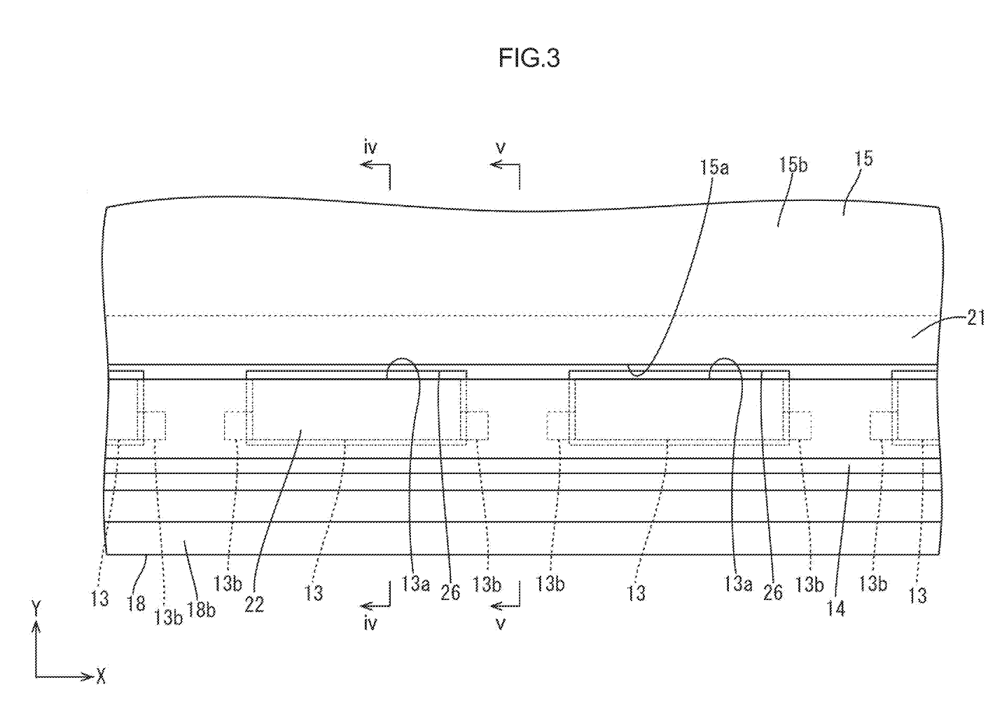

As illustrated in FIGS. 1 and 4, each LED 13 includes a LED chip (an LED element) which is a semiconductor light emitting element and is sealed with a sealing member 13S on a base board that is bonded to a plate surface of the LED board 14. The LED chip mounted on the base board having a single main light emission wavelength; specifically, the LED chip that emits light rays in a single color of blue is used. Phosphors that emit light in a predefined color when excited by the blue light from the LED chip are dispersed in the sealing member 13S that seals the LED chip. The LED chip emits substantially white light as a whole. Each LED 13 is a so-called side-surface-emitting type LED and a side surface of the LED 13 adjacent to a mounting surface that is mounted on the LED board 14 is a light emitting surface 13a. As illustrated in FIG. 3, the LED 13 has side surfaces that are adjacent to the light emitting surface 13a and includes terminals 13b on the side surfaces. The terminals 13b are connected to a trace of the LED board 14 through soldering.

As illustrated in FIGS. 1 and 4, the LED board 14 is formed of a flexible film (sheet) made of insulating material. The LED board 14 is arranged such that a plate surface thereof is parallel to plate surfaces of the liquid crystal panel 11 and other plate members. The LED board 14 has a horizontally elongated rectangular shape in a plan view. The LED board 14 is arranged within the backlight unit 12 such that a long direction of the LED board 14 corresponds with a short direction (the X-axis direction) of the backlight unit 12 and a short direction of the LED board 14 corresponds with a long direction (the Y-axis direction) of the backlight unit 12. The LEDs 13 are surface-mounted on a front plate surface of the LED board 14 (a plate surface opposite the light guide plate 15). The front plate surface of the LED board 14 is defined as a mounting surface. The trace (not illustrated) for supplying power to the LEDs 13 is formed on the mounting surface of the LED board 14 through patterning. The LED board 14 is disposed on the rear side (on an opposite plate surface 15c side) of the light guide plate 15 with respect to the Z-axis direction and to overlap the light guide plate 15.

As illustrated in FIG. 2, the LED board 14 has a belt-like shape that extends substantially straight in the X-axis direction. The LED board 14 has one edge section with respect to a width direction (the short direction, the Y-axis direction) and the one edge section overlaps the light guide plate 15 (a light entering-side edge section 21) in a plan view. The edge section is defined as a light guide plate overlapping section 14a. The LEDs 13 (six in FIGS. 1 and 2) are linearly arranged at intervals in a longitudinal direction (the X-axis direction) on the LED board 14 having such a configuration. The adjacent LEDs 13 are connected in series via the trace. Inter-LED spaces LS (a light source space) are provided between the adjacent LEDs 13. The LEDs 13 and the inter-LED spaces LS are alternately disposed in the X-axis direction on the LED board 14. The number of the inter-LED spaces LS is equal to the number of the LEDs 13 minus one (n−1 where n is the number of the LEDs 13). The arrangement direction in which the LEDs 13 and the inter-LED spaces LS corresponds with the X-axis direction. The intervals between the adjacent LEDs 13 (length dimensions of the inter-LED spaces LS) are substantially constant. Namely, the LEDs 13 are arranged at equal intervals in the X-axis direction. Power is supplied from an LED driving circuit board, which is not illustrated, to the LEDs 13 to turn on the LEDs 13. Extended lines (not illustrated) are arranged on the LED board 14 for the supply of power.

As illustrated in FIGS. 1 and 2, the light guide plate 15 has a rectangular plate shape in a plan view. The light guide plate 15 has a plate surface that is parallel to plate surfaces of the liquid crystal panel 11 and other plate members. The long direction of the plate surface corresponds with the Y-axis direction, the short direction of the plate surface corresponds with the X-axis direction, and a thickness direction perpendicular to the plate surface corresponds with the Z-axis direction. The light guide plate 15 is arranged directly below the liquid crystal panel 11 and the optical sheet 16 to be surrounded by side portions 18b of the casing 18. Among end surfaces of the light guide plate 15, a short end surface on the lower side in FIG. 2 is defined as a light entering end surface 15a (a light source opposed end surface) through which light rays from the LEDs 13 enter. Three end surfaces of the light guide plate 15 other than the light entering end surface 15a (an short-side end surface on the upper side in FIG. 2 and a pair of long end surfaces) are LED non-opposed end surfaces 15d (light source non-opposed end surfaces). Among the end surfaces of the light guide plate 15, the edge section including the light entering end surface 15a (an edge section on the lower side in FIG. 2) is a light entering-side edge section 21. The light entering-side edge section 21 overlaps the light guide plate overlapping section 14a of the LED board 14 on a front side thereof. According to such a position relation between the light entering-side edge section 21 and the light guide plate overlapping section 14a of the LED board 14, the light guide plate overlapping section 14a of the LED board 14 is covered with the light entering-side edge section 21 from the front side. Therefore, the light guide plate overlapping section 14a is less likely to be recognized by a user of the liquid crystal display device 10. If decreases in frame widths of the liquid crystal display device 10 and the backlight unit 12 further progress, the light guide plate overlapping section 14a of the LED board 14 may largely extend over an effective light exiting area EA (the display area). Even in such a case, the light guide plate overlapping section 14a is less likely to be recognized as a dark spot according to the configuration described above. This configuration is preferable for the reductions in frame widths. Light rays from the LEDs 13 are less likely to directly enter each LED non-opposed end surface 15d. However, the light rays from the LEDs 13 may indirectly enter each LED non-opposed end surface 15d.

As illustrated in FIG. 4, one of the front and rear side plate surfaces of the light guide plate 15 facing the front side (the liquid crystal panel 11 side) is a light exiting plate surface 15b through which the light rays exit toward the liquid crystal panel 11. The light exiting plate surface 15b of the light guide plate 15 is sectioned into the effective light exiting area EA and a non-effective light exiting area NEA. The effective light exiting area EA is a middle section through which light rays effectively exit. The non-effective light exiting area NEA is a peripheral section surrounding the effective light exiting area EA through which light rays do not effectively exit. Light rays exiting through the effective light exiting area EA are supplied to the display area of the liquid crystal panel 11 and effectively used for displaying images. The effective light exiting area EA overlaps the display area in a plan view. The non-effective light exiting area NEA overlaps the non-display area in a plan view. The other one of the plate surfaces of the light guide plate 15 facing the rear side is an opposite plate surface 15c that is on an opposite side from the light exiting plate surface 15b. In such a configuration, the LEDs 13 and the light guide plate 15 are arranged in the Y-axis direction and the optical sheet 16 (the liquid crystal panel 11) and the light guide plate 15 are arranged in the Z-axis direction. The arrangement directions are perpendicular to each other. The light rays emitted by the LEDs 13 in the Y-axis direction enter the light guide plate 15 through the light entering end surface 15a. The light rays travel within the light guide plate 15 toward the optical sheet 16 (toward the front side, the light exit side) and exit the light guide plate 15 through the light exiting plate surface 15b that is the front side plate surface. A light reflecting pattern (not illustrated) is formed on the opposite plate surface 15c of the light guide plate 15 for reflecting the light rays inside the light guide plate 15 toward the light exiting plate surface 15b to increase the amount of the light rays that exit through the light exiting plate surface 15b. The light reflecting pattern includes light reflectors. The light reflectors in the light reflecting pattern are light reflecting dots with a distribution density that changes according to a distance from the light entering end surface 15a (the LEDs 13). Specifically, the distribution density of the light reflecting dots of the light reflectors increases as the distance from the light entering end surface 15a in the Y-axis direction increases. The distribution density decreases as the distance to the light entering end surface 15a decreases. According to the configuration, the light rays from the light exiting plate surface 15b are evenly distributed within a plane.

As illustrated in FIG. 1, the optical sheet 16 has a rectangular plan view shape similar to that of the light guide plate 15. The plate surface of the optical sheet 16 is parallel to the plate surfaces of the light guide plate 15 and other plate members. In the plate surface, the long direction corresponds with the Y-axis direction, the short direction corresponds with the X-axis direction, and the thickness direction perpendicular to the plate surface corresponds with the Z-axis direction. The optical sheet 16 is disposed on the light exiting plate surface 15b of the light guide plate 15 on the front side and between the liquid crystal panel 11 and the light guide plate 15. With such a configuration, the optical sheet 16 exerts predefined optical effects on the light rays from the light guide plate 15 while the light rays are passing through the optical sheet 16 and then the light rays exit the optical sheet 16 toward the liquid crystal panel 11. As illustrated in FIG. 4, a peripheral edge of the optical sheet 16 projects outer than the end surface of the light guide plate 15 and a short edge section of the optical sheet 16 covers the LEDs 13 from the front side. In this embodiment, the optical sheet 16 includes three optical sheets laminated with each other. Specifically, the three optical sheets include a diffuser sheet 16a, a first prism sheet 16b, and a second prism, sheet 16c. The diffuser sheet 16a is disposed closest to the rear side and on a front side of the light exiting plate surface 15b of the light guide plate 15. The first prism sheet 16b is disposed on the front side of the diffuser sheet 16a and the second prism sheet 16c is disposed on the front side of the first prism sheet 16b. The diffuser sheet 16a includes a base member and diffuser particles dispersed in the base member. The diffuser sheet 16a is configured to scatter the light rays that pass therethrough. The diffuser sheet 16a includes a light blocking layer 16a1 in a short edge section, among edge sections of the diffuser sheet 16a. The light blocking layer 16a1 exhibits a black color and has high light absorbing properties and high light blocking properties. The light blocking layer 16a1 is formed through printing of a light blocking coating material on or application of the light blocking coating material to a surface of the diffuser sheet 16a. Because the light blocking layer 16a1 is disposed to cover the LEDs 13 from the front side, the light rays from each LED 13 are less likely to directly enter the optical sheet 16 without passing through the light guide plate 15. The light blocking layer 16a1 is disposed to overlap the non-effective light exiting area NEA in a plan view such that an inner edge of the light blocking layer 16a1 is substantially aligned with a boundary between the effective light exiting area EA and the non-effective light exiting area NEA. The first prism sheet 16b and the second prism sheet 16c include base members and prism portions on front-side plate surfaces of the base members. The prism portions include unit prisms each extending in the X-axis direction or the Y-axis direction. The unit prisms are arranged in the Y-axis direction or the X-axis direction. The light rays passing through the prism portions are refracted by the unit prisms included in the prism portions such that light collecting effects are selectively exerted on the light rays with respect to the arrangement direction of the unit prisms. The extending direction and the arrangement direction of the unit prisms of the first prism sheet 16b are perpendicular to the extending direction and the arrangement direction of the unit prisms of the second prism sheet 16c, respectively.

As illustrated in FIGS. 1 and 4, the reflection sheet 17 is disposed on the opposite plate surface 15c of the light guide plate 15 on the opposite side from the light exiting plate surface 15b to cover the opposite plate surface 15c on the rear side. The reflection sheet 17 is an insulating sheet made of synthetic resin. The reflection sheet 17 has a so-called dielectric multilayer structure including multiple dielectric layers having different refractive indexes. The dielectric multilayer structure includes multiple dielectric layers (not illustrated) having a thickness of one fourth of the wavelength of visible light and each having a different refractive index and exerts highly efficient reflecting properties without causing diffusion. One example of the reflection sheet 17 having such a configuration is “ESR” that is a product of SUMITOMO 3M Limited. The “ESR” uses a polyester resin as the dielectric material. The reflection sheet 17 reflects light rays traveling inside the light guide plate 15 to effectively direct the light rays toward the front side (toward the light exiting plate surface 15b). The reflection sheet 17 has a rectangular plan view shape similar to that of the light guide plate 15. The reflection sheet 17 is disposed on the rear side of the light guide plate (on an opposite side from the optical sheet 16) such that an entire area of the light guide plate 15 is covered with a large area of the reflection sheet 17.

The casing 18 is made of synthetic resin and formed in a substantially box shape as a whole with an opening on the front side as illustrated in FIGS. 1 and 4. The casing 18 includes a bottom portion 18a and side portions 18b. The bottom portion 18a has a rectangular plan view shape similar to the liquid crystal panel 11. The side portions 18b extend from outer edges (a pair of long sides and a pair of short sides) of the bottom portion 18a toward the front side. In the casing 18 (the bottom portion 18a), the long direction corresponds with the Y-axis direction and the short direction corresponds with the X-axis direction. The bottom portion 18a has a plate surface parallel to plate surfaces of the liquid crystal panel 11 and other plate members. Circuit boards such as a control circuit board and am LED drive circuit board, which are not illustrated, are mounted on a rear side of the casing 18. The side portions 18b are disposed to surround the LEDs 13, the LED board 14, and the light guide board 15 from the outer sides to form a vertically-long rectangular frame shape as a whole. Each side portion 18b has a cross-sectional shape including two steps. The side portion 18b includes a first step portion 18b1 that is lower and a second step portion 18b2 that is higher. A peripheral edge section of the optical sheet 16 is placed on the first step portion 18b1 and a peripheral edge section of the liquid crystal panel 11 is placed on the second step portion 18b2.

As illustrated in FIGS. 1 and 4, the casing 18 is fixed to the liquid crystal panel 11 with a panel fixing member 19. The panel fixing member 19 includes a surface that exhibits black and has high light absorbing properties and high light blocking properties. The panel fixing member 19 has a rectangular frame plan view shape similarly to the side portion 18b of the casing 18. The panel fixing member 19 defines the effective light exiting area EA within the light exiting plate surface 15b of the light guide plate 15. Namely, the panel fixing member 19 overlaps the non-effective light exiting area NEA within the light exiting plate surface 15b of the light guide plate 15 in a plan view. The panel fixing member 19 is a double-sided adhesive type including a base member and adhesives applied to front and rear surfaces of the base member. It is preferable that the base member of the panel fixing member 19 itself is made of black material (such as black PET). However, the base member may be made of white material or transparent material and the surface of the base member may be coated with the black material through printing. The panel fixing member 19 is disposed between the second step portion 18b2 of the side portion 18b of the casing and the peripheral edge section of the liquid crystal panel 11 with respect to the Z-axis direction. The adhesives on the front and rear surfaces of the panel fixing member 19 adhere to the second step portion 18b2 and the peripheral edge section, respectively. Furthermore, the panel fixing member 19 is disposed between the optical sheet 16 and the liquid crystal panel 11 with respect to the Z-axis direction and fixed to the optical sheet 16 (specifically, the second prism sheet 16c that is closest to the front side). The LED board 14 is fixed to the bottom portion 18a of the casing 18 with a board fixing member 20. The board fixing member 20 has a horizontally-long belt shape in a plan view similar to the LED board 14. The board fixing member 20 is a double-sided adhesive type including a base member and adhesives applied to front and rear surfaces of the base member. The board fixing member 20 is disposed between the bottom portion 18a of the casing 18 and the LED board 14 with respect to the Z-axis direction and the adhesives on the front and rear surfaces of the board fixing member 20 adheres to the bottom portion 18a and the LED board 14, respectively,

The amount of light rays emitted by the LEDs 13 and entering the light guide plate 15 through the light entering end surface 15a is relatively large in sections opposite the respective LEDs 13 and tends to be relatively smaller in sections opposite the respective inter-LED spaces LS each of which is between the adjacent LEDs 13. If such a difference occurs in the amount of light rays entering through the light entering end surface 15a, the amount of light rays travelling within the light guide plate 15 and exiting through the light exiting plate surface 15b may vary according to positions within the plate surface of the light exiting plate surface 15b. This may result in unevenness in brightness of exiting light.

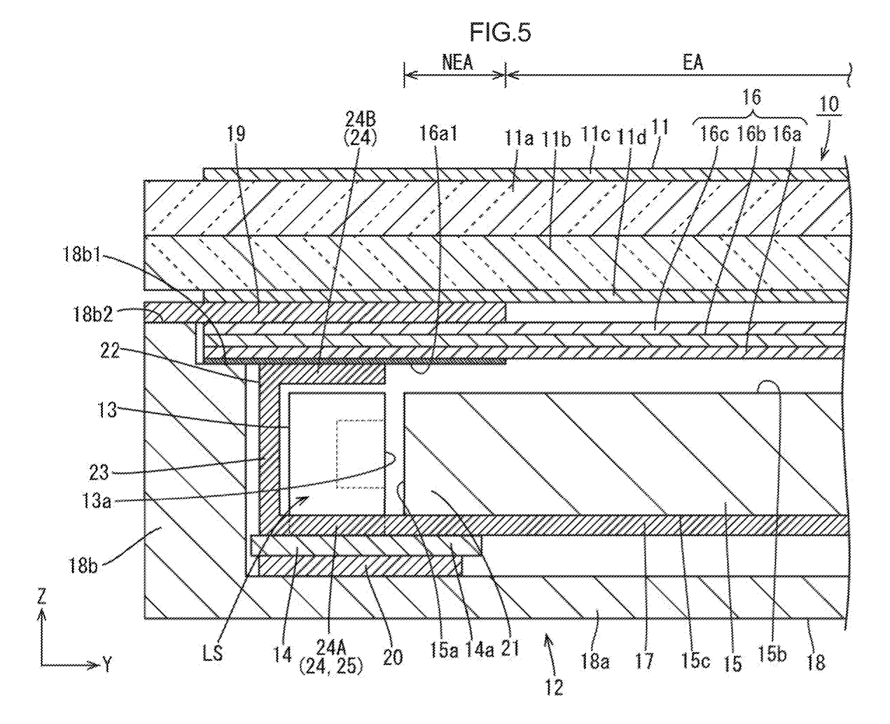

As illustrated in FIGS. 1 and 5, a hood-shaped reflection member 22 is integrated with the reflection sheet 17 in this embodiment. The hood-shaped reflection member 22 surrounds the inter-LED spaces LS between the adjacent LEDs 13 and opens toward the light guide plate 15. The hood-shaped reflection member 22 includes a first reflection portion 23 and a pair of second reflection portions 24. The first reflection portion 23 is opposite the light entering end surface 15a of the light guide plate 15 via the inter-LED spaces LS. The second reflection portions 24 are continuous from the first reflection portion 23 and sandwich the inter-LED spaces LS therebetween from two sides with respect to the Z-axis direction (a plate thickness direction of the light guide plate 15). According to the hood-shaped reflection member 22 having such a configuration, the light rays emitted by the LEDs 13 and travelling into the inter-LED spaces LS are reflected by the first reflection portion 23 and the pair of second reflection portions 24 such that the reflected light rays are mixed within the inter-LED spaces LS and effectively exit through the opening of the hood-shaped reflection member 22 toward the light entering end surface 15a of the light guide plate 15. The light rays exiting through the opening of the hood-shaped reflection member 22 mainly enter the sections of the light entering end surface 15a that are opposite the inter-LED spaces LS. Therefore, a difference in the amount of entering light rays between the sections opposite the inter-LED spaces LS and the sections opposite the LEDs 13 in the light entering end surface 15a is smaller. Accordingly, the unevenness in brightness of the exit light rays is less likely to occur within the surface plane of the light exiting plate surface 15b of the light guide plate 15. Furthermore, in the hood-shaped reflection member 22, unevenness in brightness is less likely to occur because the reflected light rays in the inter-LED spaces LS are mixed together. Therefore, brightness is less likely to be lowered compared to a known configuration for reducing unevenness in brightness by absorbing light rays. The hood-shaped reflection member 22 is integrated with the reflection sheet 17. According to such a configuration, the hood-shaped reflection member 22 has high light reflectivity similar to that of the reflection sheet 17. Furthermore, the number of components and the number of mounting steps are reduced and thus a cost related to mounting of the hood-shaped reflection member 22 can be reduced.

As illustrated in FIGS. 4 to 6, the hood-shaped reflection member 22 surrounds not only the inter-LED spaces LS but also the LEDs 13. Namely, the hood-shaped reflection member 22 extends in the X-axis direction (the arrangement direction of the LEDs 13) such that the first reflection portion 23 and the pair of second reflection portions 24 are opposite the LEDs 13 that are adjacent to the inter-LED spaces LS. Furthermore, the hood-shaped reflection member 22 extends in the X-axis direction such that the first reflection portion 23 and the pair of second reflection portions 24 are opposite all of the LEDs 13. The hood-shaped reflection member 22 is formed from an extended section that extends from one short edge section of the reflection sheet 17 near the LEDs 13 over an entire length of the short edge section in the Y-axis direction (the arrangement direction of the LEDs 13 and the light guide plate 15). The extended section is bent inwardly twice and the hood-shaped reflection member 22 is formed in a hood shape (a cross-sectional channel shape). Therefore, the hood-shaped reflection member 22 opens toward the light guide plate 15 in the Y-axis direction and also open toward both ends in the X-axis direction (the arrangement direction of the LEDs 13). According to such a configuration, all of the inter-LED spaces LS and the all of the LEDs 13 are collectively surrounded by the first reflection portion 23 and the pair of second reflection portions 24 of the hood-shaped reflection member 22. Therefore, light use efficiency is significantly high. This configuration is further preferable for restricting the reduction in brightness. Furthermore, mounting and production of the hood-shaped reflection member 22 are simplified. Therefore, this configuration is preferable for a cost reduction.

As illustrated in FIGS. 4 and 5, the pair of second reflection portions 24 of the hood-shaped reflection member 22 include a backside second reflection portion 24A (an opposite plate side second reflection portion) and a front-side second reflection portion 24B (a light exiting plate surface side second reflection portion). The backside second reflection portion 24A is disposed on a rear side (on the opposite plate surface 15c side with respect to a plate thickness direction of the light guide plate 15) with respect to the Z-axis direction and the front-side second reflection portion 24B is disposed on a front side (on a light exiting plate surface 15b side with respect to the plate thickness direction of the light guide plate 15) with respect to the Z-axis direction. In the following description, to distinguish two second reflection portions 24 from each other, the backside second reflection portion will be indicated by the reference numeral with letter “A” at the end and the front-side second reflection portion will be indicated by the reference numeral with letter “B” at the end. To describe the second reflection portions 24 without distinguishing them from each other, they will be indicated by the reference numeral without the letters. The backside second reflection portion 24A extends from the first reflection portion 23 in the Y-axis direction to a plane on which the light entering end surface 15a of the light guide plate 15 is located. The backside second reflection portion 24A is connected to a main portion of the reflection sheet 17 (a portion overlapping the light guide plate 15 on the rear surface side). Namely, the backside second reflection portion 24A is disposed in an area overlapping the LEDs 13 and the inter-LED spaces LS in a plan view and an area overlapping spaces between the light entering end surface 15a and the LEDs 13 and spaces between the light entering end surface 15a and the inter-LED spaces LS in the plan view. The front-side second reflection portion 24B extends from the first reflection portion 23 in the Y-axis direction to a plane on which the light emitting surfaces 13a of the LEDs 13. Thus, an entire area in which the LED 13 and the inter-LED spaces LS are located is sandwiched between the two second reflection portions 24 from the front side and the rear side with respect to the Z-axis direction. Therefore, the reflected light rays can be sufficiently mixed together in the LED spaces and thus sufficiently high light use efficiency can be achieved. Furthermore, the front-side second reflection portion 24B does not project toward the light guide plate 15 beyond the light emitting surface 13a of the LED 13 with respect to the Y-axis direction. Therefore, the hood-shaped reflection member 22 is less likely to be recognized by a user of the backlight unit 12 even if the backlight unit 12 has a smaller frame width.

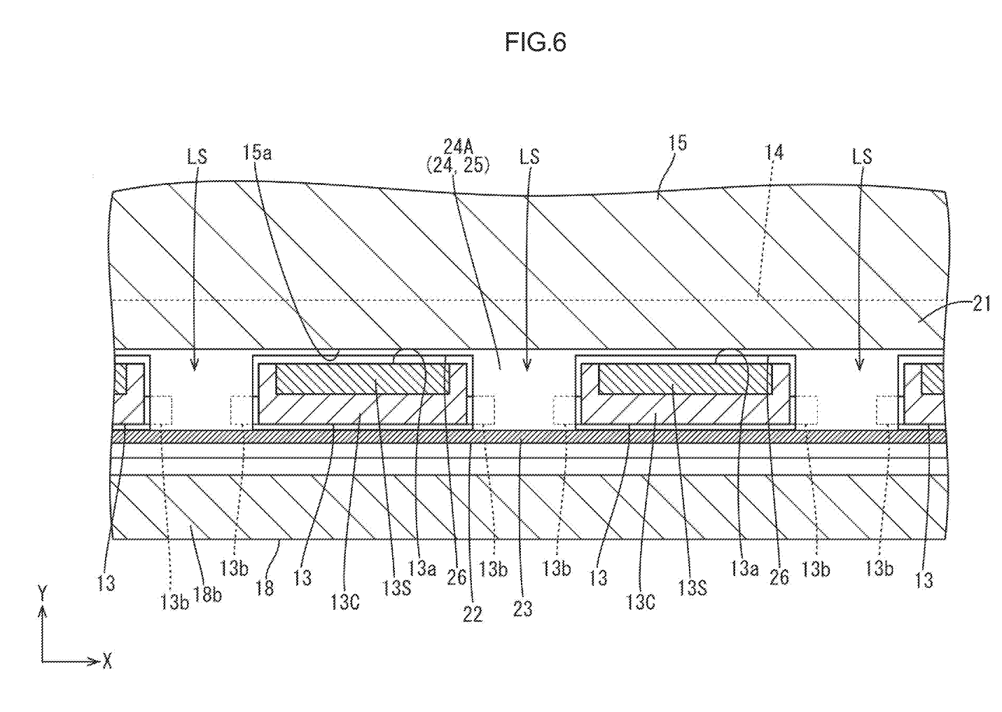

As illustrated in FIGS. 4 and 5, the hood-shaped reflection member 22 is disposed on a front side relative to the LED board 14, that is, a mounting side of the LED board 14 on which the side-surface light emission type LED 13 are mounted such that the backside second reflection portion 24A overlaps the LED board 14. The backside second reflection portion 24A, which is an overlapping portion, is defined as an LED board overlapping portion 25 (a light source board overlapping portion). As illustrated in FIGS. 4 and 6, the LED board overlapping portion 25 includes LED insertion through holes (light source insertion through holes) 26 in which the LEDs 13 are inserted, respectively. Each of the LED insertion through holes 26 has a rectangular plan view shape that is slightly greater than an outer shape of a casing 13C of each LED 13 such that the casing 13C can be easily inserted therein. Most part of the terminal 13b of the LED 13 is not inserted in the LED insertion through hole 26 to overlap the backside second reflection portion 24A. The arrangement of the LED insertion through holes 26 in the backside second reflection portion 24A is similar to the arrangement of the LEDs 13 on the LED board 14, that is, the LED insertion through holes 26 are linearly arranged at intervals along the X-axis direction.

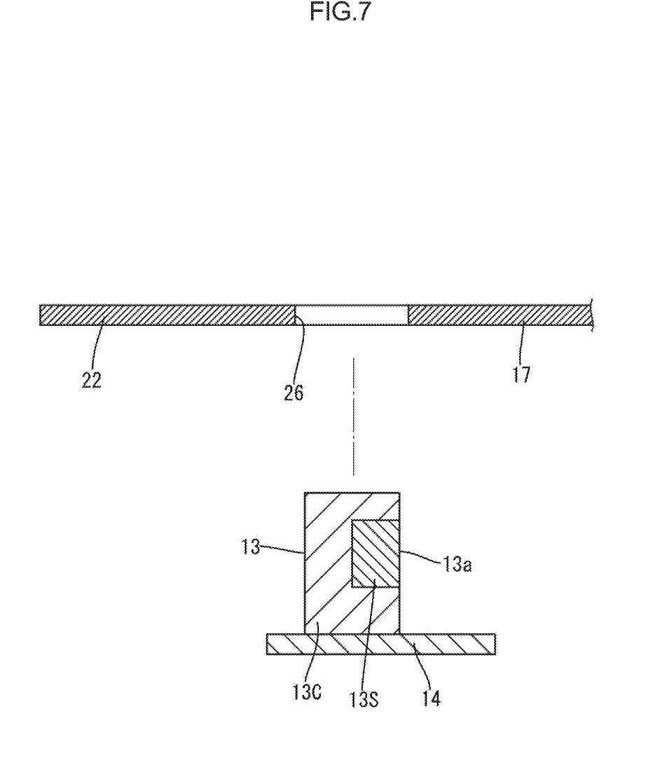

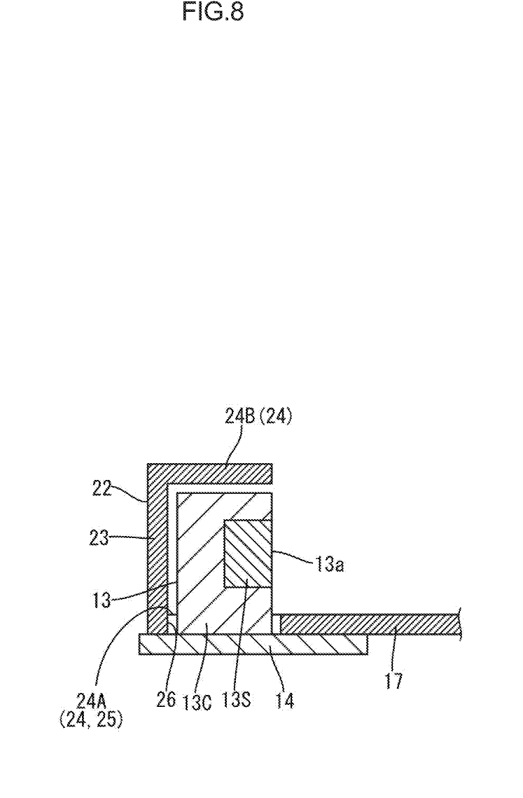

To mount the hood-shaped reflection member 22, which is integrated with the reflection sheet 17, to the LED board 14, as illustrated in FIG. 7, the hood-shaped reflection member 22 that is placed on a front side with respect to the LED board 14 is brought closer to the LED board 14 until the LEDs 13 are inserted into the respective LED insertion through holes 26. As illustrated in FIG. 8, the backside second reflection portion 24A of the hood-shaped reflection member 22 is disposed on the front side relative to the LED board 14 to overlap the LED board 14. According to such a configuration, the LED board overlapping portion 25 of the hood-shaped reflection member 22 on a LED 13 mounting side overlaps the LED board 14 and configures the backside second reflection portion 24A of the pair of second reflection portions 24. Therefore, the light rays in the inter-LED spaces LS are efficiently reflected and directed toward the light entering end surface 15a of the light guide plate 15. In this embodiment, as illustrated in FIG. 7, the LEDs 13 are inserted in the respective LED insertion through holes 26 that are formed in the extended section of the reflection sheet 17 in a state before the hood-shaped reflection member 22 is formed. Then, the extended section of the reflection sheet 17 is bent twice to form the hood-shaped reflection member 22 as illustrated in FIG. 8.

The present embodiment has the above configuration and operations thereof will be described. The operations of the backlight unit 12 will be mainly described in detail. When the LEDs 13 are turned on, the LEDs 13 emit light rays. The light rays enter the light guide plate 15 through the light entering end surface 15a as illustrated in FIG. 4. The light rays entering through the light entering end surface 15a may be totally reflected by the interface between the light guide plate 15 and the outside air layer or reflected by the reflection sheet 17 to travel through the light guide plate 15. The light rays traveling inside the light guide plate 15 exit through the light exiting plate surface 15b and are directed toward the optical sheet 16. The amount of light rays emitted by the LEDs 13 and entering the light guide plate 15 through the light entering end surface 15a is relatively large in sections opposite the respective LEDs 13 and tends to be relatively smaller in sections opposite the respective Inter-LED spaces LS each of which is between the adjacent LEDs

As illustrated in FIGS. 5 and 6, the hood-shaped reflection member 22 is integrated with the reflection sheet 17 of this embodiment. The hood-shaped reflection member 22 surrounds the inter-LED spaces LS that are between the adjacent LEDs 13 and opens toward the light guide plate 15. With such a configuration, the light rays entering the inter-LED spaces LS from the LEDs 13 can be efficiently reflected by the first reflection portion 23 and the pair of second reflection portions 24 of the hood-shaped reflection member 22. Therefore, the light rays in the inter-LED spaces LS are less likely to leak through other parts than the opening of the hood-shaped reflection member 22. The light rays reflecting off the hood-shaped reflection member 22 are sufficiently mixed together in the inter-LED spaces LS and efficiently exit toward the light entering end surface 15a of the light guide plate 15 through the opening of the hood-shaped reflection member 22. The light rays exiting through the opening of the hood-shaped reflection member 22 are sufficiently mixed together in the inter-LED spaces LS as described before and substantially linear light rays similar to the light rays emitted by the LEDs 13 through the light emitting surfaces 13a are obtained. The light rays exiting through the opening of the hood-shaped reflection member 22 mainly enter the sections of the light entering end surface 15a that are opposite the inter-LED spaces LS. Therefore, a difference in the amount of entering light rays between the sections opposite the inter-LED spaces LS and the sections opposite the LEDs 13 in the light entering end surface 15a is smaller. Accordingly, the unevenness in brightness of the exit light rays is less likely to occur within the surface plane of the light exiting plate surface 15b of the light guide plate 15. Furthermore, in the hood-shaped reflection member 22, the unevenness in brightness is reduced by mixing the reflected light rays in the LED spaces. Therefore, brightness is less likely to be lowered compared to a known configuration for reducing brightness unevenness by absorbing light rays. The hood-shaped reflection member 22 collectively surrounds all of the inter-LED spaces LS and the LEDs 13. Therefore, light use efficiency is further improved. This configuration is further preferable for restricting the reduction in brightness.

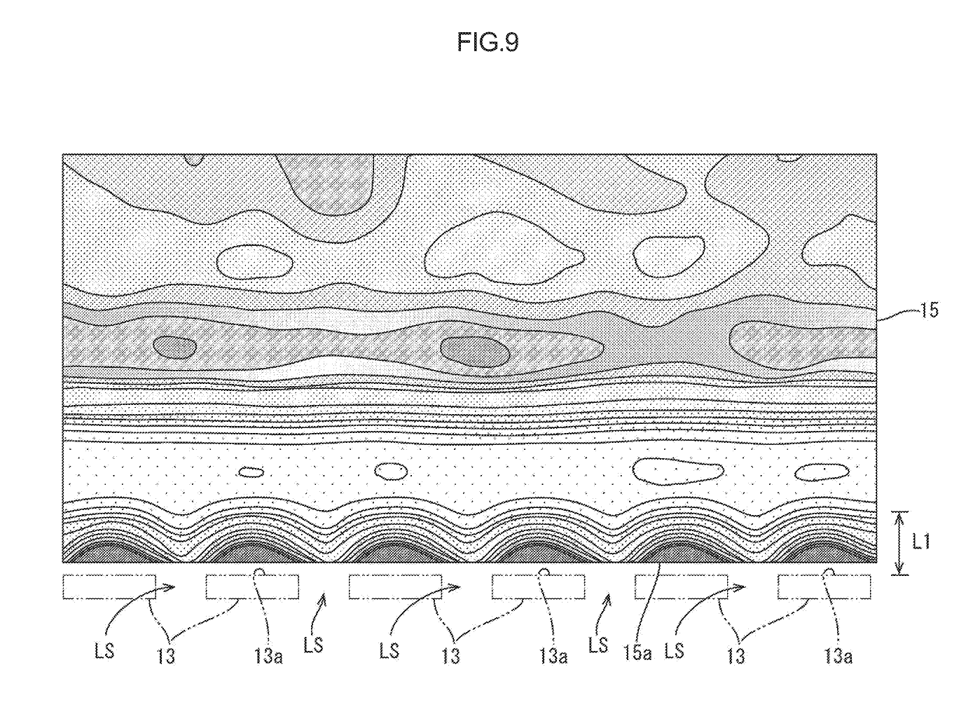

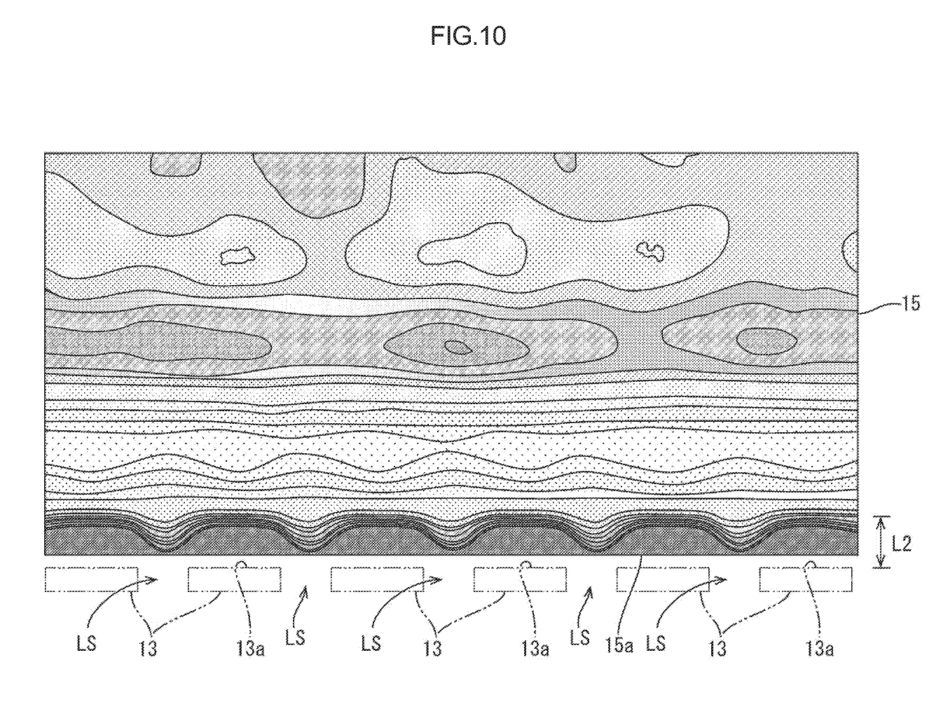

To prove the above operations and effects, the following comparative experiment was conducted. In the comparative experiment, a comparative example and an embodiment were used. The comparative example is a backlight unit that includes a reflection sheet without the hood-shaped reflection member 22. The embodiment is the backlight unit 12 that includes the reflection sheet 17 with which the hood-shaped reflection member 22 described above is integrated. Brightness distributions within the planes of the light exiting plate surfaces 15b of the light guide plates 15 were measured while the LEDs 13 in the backlight units of the comparative example and the embodiment were turned on. Results of the comparative experiment are provided in FIGS. 9 and 10. In FIGS. 9 and 10, a density of dots is varied according to a level of brightness that represents an amount of light rays in a unit area of the light exiting plate surface 15b. The higher the density of the dots is, the lower the brightness is. The lower the density of the dots is, the higher the brightness is. In an area with the highest brightness (an area closest to the LED 13 in FIGS. 9 and 10), no dot exists. In FIGS. 9 and 10, L1 and L2 indicate entrance lengths that measure between the light emitting surfaces 13a of the LEDs 13 and outer edges of the effective light exiting area EA. The entrance lengths L1 and L2 measure between the light emitting surface 13a of the LED 13 and a position at which it is determined that no unevenness is observed in brightness of light exiting through the light exiting plate surface 15b.

The results of the comparative experiment will be described. As illustrated in FIG. 9, a difference between the amount of light rays exiting from areas of the light exiting plate surface 15b of the light guide plate 15 overlapping the LEDs 13 with respect to the X-axis direction and the amount of light rays exiting from areas thereof overlapping the inter-LED spaces LS with respect to the X-axis direction is larger in the backlight unit of the comparative example in comparison to the embodiment. In the comparative example, the unevenness is more likely to be observed in brightness of the exiting light and thus the entrance length L1 is more likely to be larger. Therefore, a frame width of the comparative example is more likely to be set larger. Furthermore, the amount of light rays exiting through the light exiting plate surface 15b (the amount of dots representing the amount of exiting light rays in FIG. 9) is smaller as a whole in comparison to the embodiment. The light use efficiency and the brightness may not be sufficiently high. As illustrated in FIG. 10, a difference between the amount of light rays exiting from areas of the light exiting plate surface 15b of the light guide plate 15 overlapping the LEDs 13 with respect to the X-axis direction and the amount of light rays exiting from areas thereof overlapping the inter-LED spaces LS with respect to the X-axis direction in smaller in the backlight unit 12 of the embodiment in comparison to the comparative example. In the embodiment, the unevenness is less likely to be observed in brightness of the exiting light and thus the entrance length L2 is more likely to be smaller. Therefore, a frame width of the embodiment can be reduced. In the embodiment, the amount of light rays exiting through the light exiting plate surface 15b (the amount of clots representing the amount of exit light rays in FIG. 10) is greater as a whole in comparison to the comparative example. Therefore, the light use efficiency and the brightness are sufficiently high. This is preferable for reducing power consumption.

As described above, the backlight unit 12 (the lighting device) according to this embodiment includes the LEDs 13 (light sources) which are linearly arranged at intervals, the light guide plate 15 that is a flat plate, and the hood-shaped reflection member 22. The light guide plate 15 includes end surfaces and the pair of plate surfaces. At least one end surface is the light entering end surface 15a that extends in a direction in which the LEDs 13 are arranged and is opposite the light emitting surfaces 13a of the LEDs 13. One of the plate surfaces is the light exiting plate surface 15b through which light rays exit. The hood-shaped reflection member 22 surrounds the inter-LED spaces LS (the light source space) at least between the adjacent LEDs 13 and opens at least toward the light guide plate 15. The hood-shaped reflection member 22 at least includes the first reflection portion 23 and the pair of second reflection portions 24. The first reflection portion 23 is opposite the light entering end surface 15a and the second reflection portions 24 are continuous from the first reflection portion 23 and sandwich the inter-LED spaces LS from two sides with respect to a plate thickness direction of the light guide plate 15.

According to such a configuration in which the LEDs 13 are linearly arranged at intervals, the light entering end surface 15a is one of the end surfaces of the light guide plate 15 having the flat plate shape opposed to the light emitting surfaces 13a, and the light exiting plate surface 15b is one of the plate surfaces of the light guide plate 15, the light rays that have exited through the light emitting surfaces 13a enter the light guide plate 15 through the light entering end surface 15a, travel through the light guide plate 15, and exit through the light exiting plate surface 15b. The amount of light rays entering through the light entering end surface 15a is relatively large in sections opposite the respective LEDs 13 and tends to be relatively smaller in sections opposite the respective Inter-LED spaces LS each of which is between the adjacent LEDs 13. The unevenness in brightness may occur in exiting light within the plane of the light exiting plate surface 15b due to the difference in the amount of entering light rays. The hood-shaped reflection member 22 includes the first reflection portion 23 that surrounds at least the LED 13 and opens at least toward the light guide plate 15 and is opposite the light entering end surface 15a and a pair of second reflection portions 24 that are continuous from the first reflection portion 23 and sandwich the inter-LED spaces LS from two sides with respect to the plate thickness direction of the light guide plate 15. Therefore, the light rays entering the inter-LED spaces LS from the LEDs 13 can be efficiently reflected by the first reflection portion 23 and the pair of second reflection portions 24. The reflected light rays are sufficiently mixed together in the inter-LED spaces LS and efficiently exit toward the light entering end surface 15a through the opening of the hood-shaped reflection member 22. The light rays exiting through the opening of the hood-shaped ref lection member 22 mainly enter the sections of the light entering end surface 15a that are opposite the inter-LED spaces LS. Therefore, difference in the amount of entering light rays between the sections opposite the inter-LED spaces LS and the sections opposite the LEDs 13 in the light entering end surface 15a is smaller. Accordingly, the unevenness in brightness of the exit light rays is less likely to occur in the plane of the light exiting plate surface 15b. Furthermore, in the hood-shaped reflection member 22, the unevenness in brightness can be reduced by mixing the reflected light rays in the inter-LED spaces LS. Therefore, brightness is less likely to be reduced in comparison to a known configuration for reducing the unevenness in brightness by absorbing light rays.

The hood-shaped reflection member 22 extends in the arrangement direction such that the first reflection portion 23 and the pair of second reflection portions 24 are opposite at least one of the LEDs 13. According to such a configuration, the LEDs 13 adjacent to the inter-LED spaces LS are surrounded by the first reflection portion 23 and the pair of second reflection portions 24 included in the hood-shaped reflection member 22. Therefore, light use efficiency is further improved. This configuration is further preferable for restricting the reduction in brightness. Furthermore, the mounting and production of the hood-shaped reflection member 22 can be simplified.

The hood-shaped reflection member 22 extends along the arrangement direction such that the first reflection portion 23 and the second reflection portions 24 are opposed to all the LEDs 13. In this configuration, all the LEDs 13 and the inter-LED spaces LS are collectively surrounded by the first reflection portion 23 and the second reflection portions 24 of the hood-shaped reflection member 22. Therefore, further higher light use efficiency can be achieved. This configuration is further preferable for restricting the reduction in brightness.

The hood-shaped reflection member 22 is disposed such that the second reflection portion 24 on the light exiting plate surface 15b side relative to the inter-LED spaces LS in the thickness direction in the pair of the second reflection portions 24 is on the plane on which the light emitting surfaces 13a of the LEDs 13 are disposed. According to the configuration, the reflected light rays are sufficiently mixed together in the inter-LED spaces LS and thus sufficiently high light use efficiency can be achieved. Furthermore, the hood-shaped reflection member 22 is less likely to be recognized by the user of the backlight unit 12 even if the frame width of the backlight unit 12 is reduced.

This embodiment includes the LED board 14 (The light source board) on which the LEDs 13 are mounted. The hood-shaped reflection member 22 is disposed on the LED 13 mounting side relative to the LED board 14 to overlap the LED board 14. The hood-shaped reflection member 22 includes the LED board overlapping portion 25 (the light source board overlapping portion) which is configured as any one of the first reflection portion 23 and the second reflection portions 24. The LED board overlapping portion 25 includes the LED insertion through holes 26 (the light source through holes) in which the respective LEDs 13 are inserted. Because the LED board overlapping portion 25 included in the hood-shaped reflection member 22 is disposed on the LED 13 mounting side relative to the LED board 14 to overlap the LED board 14 and configured as any one of the first reflection portion 23 and the second reflection portions 24, the LED board overlapping portion 25 can efficiently reflect the light rays in the inter-LED spaces LS toward the light entering end surface 15a of the light guide plate 15. Furthermore, the LEDs 13 are inserted in the respective LED insertion through holes 26 in the LED board overlapping portion 25 that is disposed as described above.

The LED board overlapping portion 25 is configured as any one of the second reflection portions 24 of the hood-shaped reflection member 22. This configuration is preferable when the LED board 14 on which the side-emitting type LEDs 13 are mounted is used.

This embodiment includes the reflection sheet 17 (the light guide plate reflection member) disposed to overlap the opposite plate surface 15c on the opposite side from the light exiting plate surface 15b of the light guide plate to reflect the light rays. The hood-shaped reflection member 22 is integrated with the reflection sheet 17. According to the configuration, the light rays traveling inside the light guide plate 15 can be reflected toward the light exiting plate surface 15b by the reflection sheet 17. Because the hood-shaped reflection member 22 is integrated with the reflection sheet 17, the hood-shaped reflection member 22 has high light reflectivity at the same level as the light reflectivity of the reflection sheet 17. Furthermore, the number of parts and the number of assembly steps can be reduced. Therefore, the cost related to the installation of the hood-shaped reflection member 22 can be reduced.

The liquid crystal display device 10 (the display device) according to this embodiment includes the backlight unit 12 described above and the liquid crystal panel 11 (the display panel) configured to perform image display using the light from the backlight unit 12. Because the unevenness and the reduction in brightness are less likely to occur in light emitted by the backlight unit 12, the liquid crystal display device 10 having the above configuration can perform the image display with high display quality.

### Second Embodiment

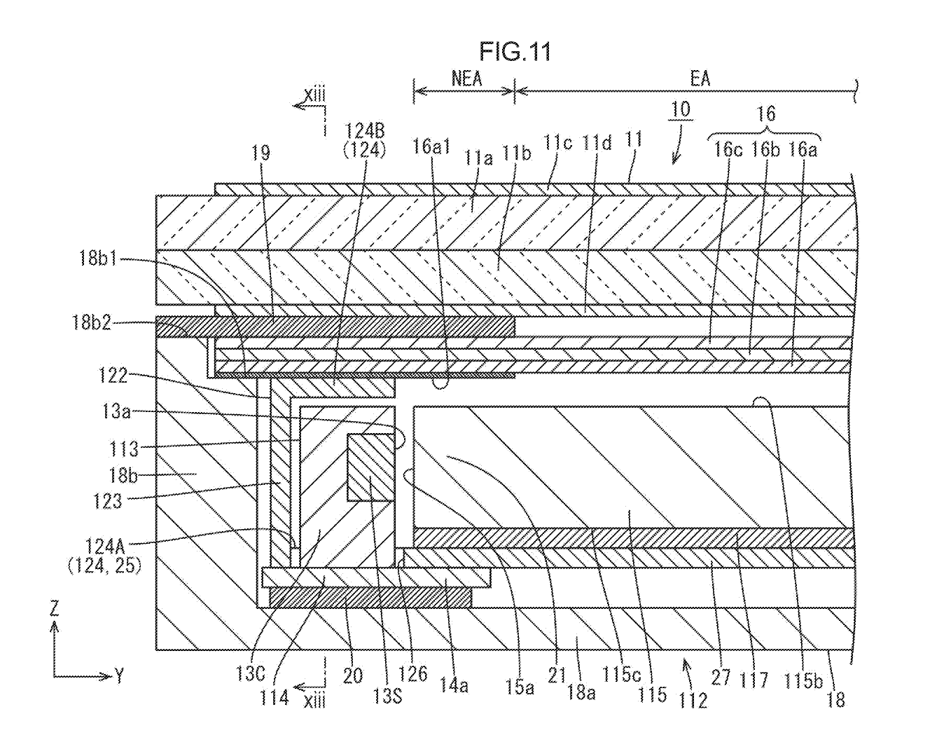

A second embodiment of the present invention will be described with reference to FIGS. 11 to 15. The second embodiment includes a hood-shaped reflection member 122 that is integrated with a component different from that of the first embodiment. Configuration, functions, and effects similar to those of the first embodiment will not be described.

As illustrated in FIG. 11, a backlight unit 112 according to this embodiment includes a holding member 27 on a backside of a reflection sheet 117, that is, on an opposite side from a light guide plate 115 to overlap the reflection sheet 117. The reflection sheet 117 is sandwiched between the light guide plate 115 and the holding member 27. The hood-shaped reflection member 122 is integrated with the holding member 27. Because the hood-shaped reflection member 122 and the holding member 27 are provided as a single component, the number of parts and the number of assembly steps can be reduced. Therefore, the cost related to installation of the hood-shaped reflection member 122 can be reduced.

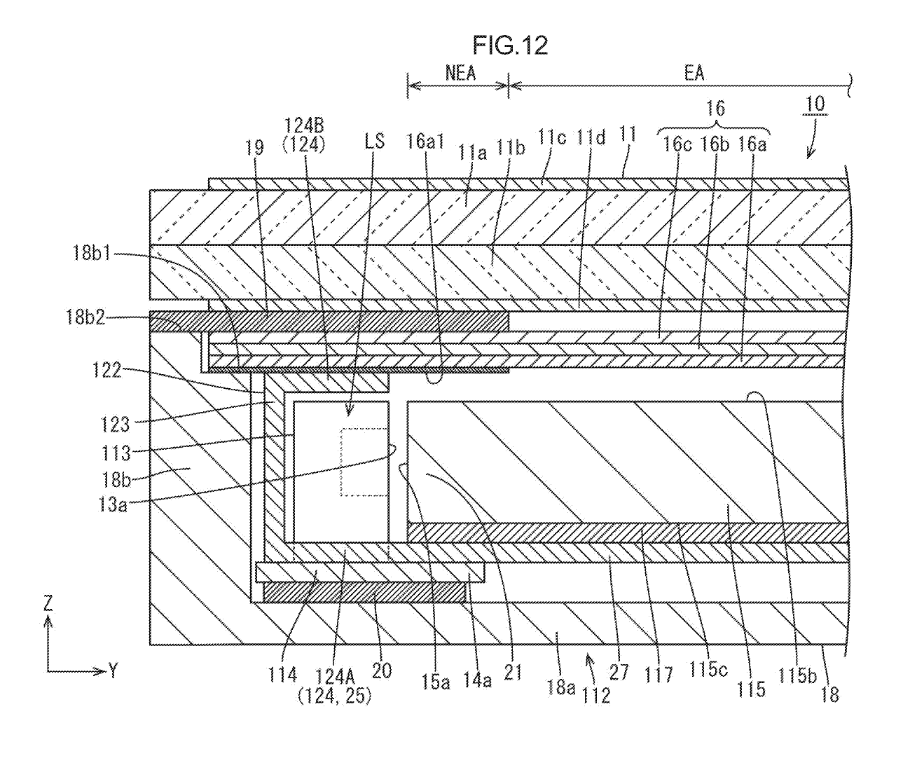

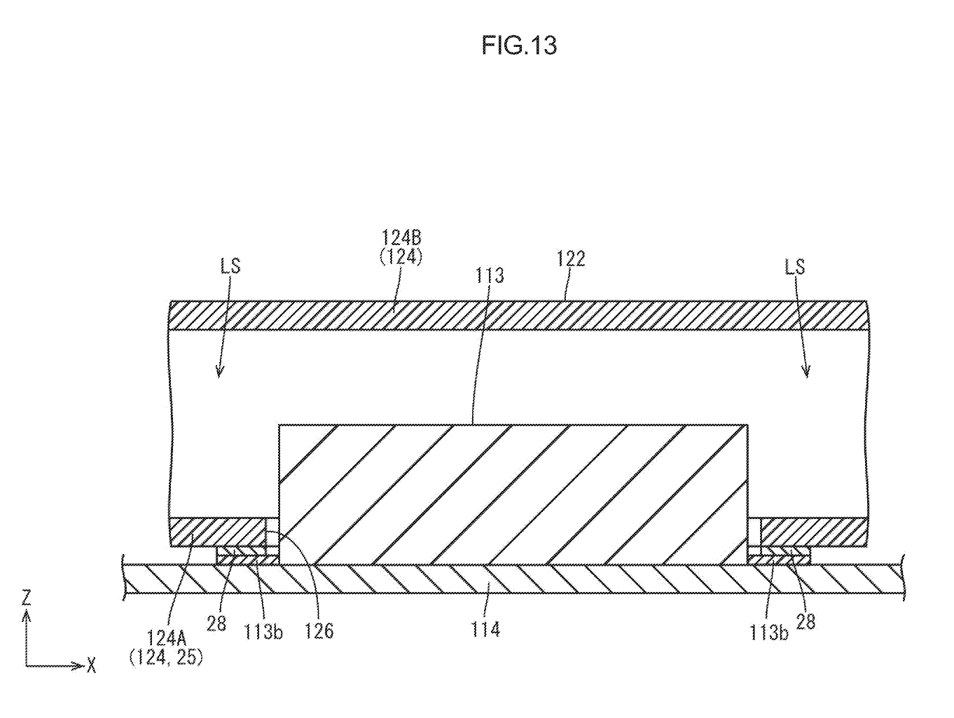

Specifically, the holding member 27 is a plate member made of metal having conductivity (e.g., stainless steel and aluminum). A large portion of the holding member 27 disposed parallel to the light guide plate 115 and the reflection sheet 117 is defined as a main portion. The holding member 27 is disposed such that the main portion covers an about entire area of the reflection sheet 117 from the rear side. The holding member 27 holds the about entire area of the reflection sheet 117 in close contact with an opposite plate surface 115c of the light guide plate 115. According to the configuration, the reflection sheet 117 has high shape stability. Therefore, light rays can be properly directed toward a light exiting plate surface 115b by the reflection sheet 117. As illustrated in FIGS. 11 and 12, the hood-shaped reflection member 122 is connected to one of the short edges of the main portion of the holding member 27 on an LED 113 side and provided as the single component. As illustrated in FIG. 13, insulators 28 are disposed on the back surface of the hood-shaped reflection member 122 opposed to an LED board 114 at positions overlapping terminals 113b of the LEDs 113. The insulators 28 insulate the terminals 113b from the hood-shaped reflection member 122 that is made of metal. The insulators 28 are made of insulating material (e.g., silicon dioxide and fluorine resin) and formed in film shapes. The insulators 28 are formed by coating target areas of the surface of the hood-shaped reflection member 122. With the insulators 28, the terminals 113b of the LEDs 113 are less likely to directly contact the hood-shaped reflection member 122 and thus a short circuit is less likely to be developed. Detailed features of the hood-shaped reflection member 122 other than the features described above are similar to those of the first embodiment. The hood-shaped reflection member 122 includes a first reflection portion 123 and a pair of second reflection portions 124 (a backside second reflection portion 124A and a front-side second reflection portion 124B).

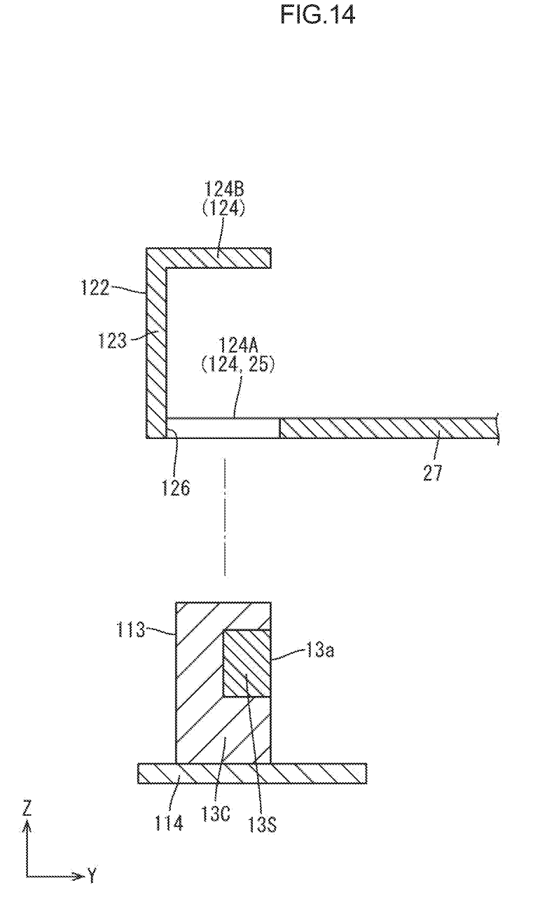

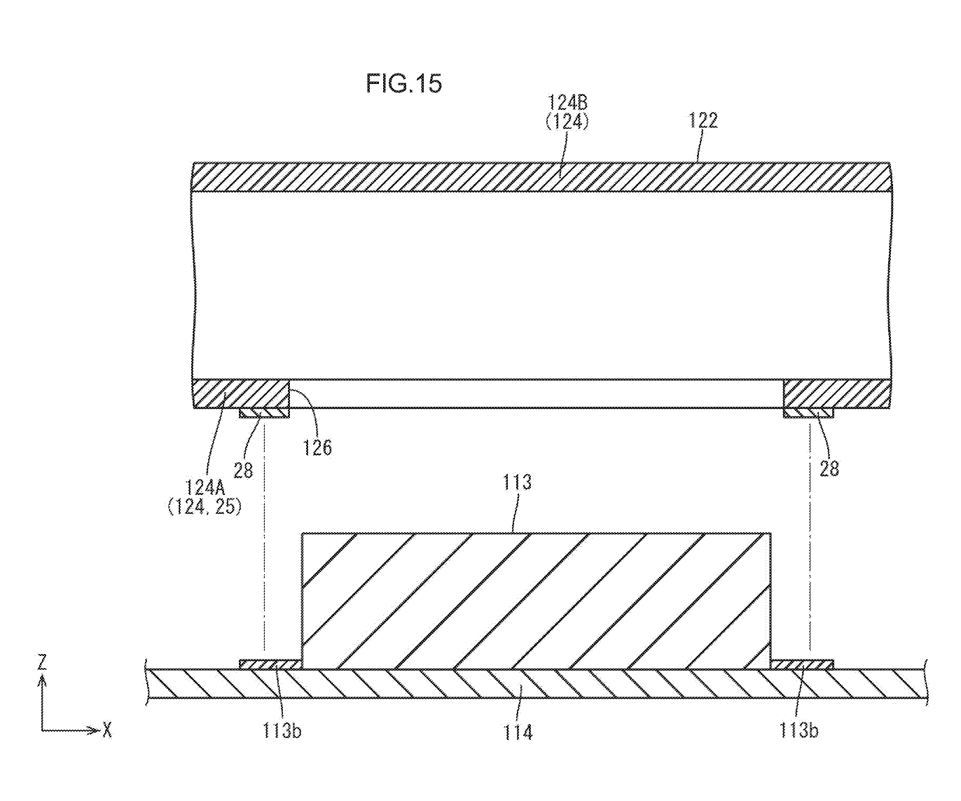

To mount the hood-shaped reflection member 122 that is integrated with the holding member 27 to the LED board 114, as illustrated in FIGS. 14 and 15, the hood-shaped reflection member 122 is placed on the front side of the LED board 114 and brought closer to the LED board 114 until the LEDs 113 are inserted into LED insertion through hole 126. As illustrated in FIGS. 11 and 13, the backside second reflection portion 124A of the hood-shaped reflection member 122 is disposed on the front side relative to the LED board 114 to overlap the LED board 114 and the insulators 28 are disposed on the front side relative to the terminals 113b of the LEDs 113 to overlap the terminals 113b. The terminals 113b directly contact the backside second reflection portion 124A and thus a short circuit is less likely to be developed.

As described above, this embodiment includes the reflection sheet 117 and the holding member 27. The reflection sheet 117 is disposed to overlap the opposite plate surface 115c of the light guide plate 115 on the opposite side from the light exiting plate surface 115b and configured to reflect the light rays. The holding member 27 is disposed on the opposite side from the light guide plate 115 relative to the reflection sheet 117 to overlap the reflection sheet 117 such that the reflection sheet 117 is sandwiched between the light guide plate 115 and the holding member 27. The hood-shaped reflection member 122 is integrated with the holding member 27. According to the configuration, the light rays traveling inside the light guide plate 115 can be reflected toward the light exiting plate surface 115b by the reflection sheet 117. Because the reflection sheet 117 is sandwiched between the light guide plate 115 and the holding member 27, the reflection sheet 117 has high shape stability. Therefore, the light rays can by properly directed toward the light exiting plate surface 115b by the reflection sheet 117. Because the holding member 27 and the hood-shaped reflection member 122 are provided as a single component, the number of parts and the number of assembly steps can be reduced and thus the cost related to the installation of the hood-shaped reflection member 122 can be reduced.

The LEDs 113 include the terminals 113b connected to the LED board 114, respectively. The hood-shaped reflection member 122 is made of metal having conductivity. The insulators 28 are disposed on the surface of the hood-shaped reflection member 122 opposed to the LED board 114 at the positions to overlap the terminals 113b. Although the hood-shaped reflection member 122 disposed to overlap the LED board 114 is made of metal having conductivity, the terminals 113b of the LEDs 113 are less likely to directly contact the hood-shaped reflection member 122 because the insulators 28 are disposed on the surface opposed to the LED board 114 at the positions to overlap the terminals 113b of the LEDs 113. Therefore, a short circuit is less likely to be developed.

### Third Embodiment

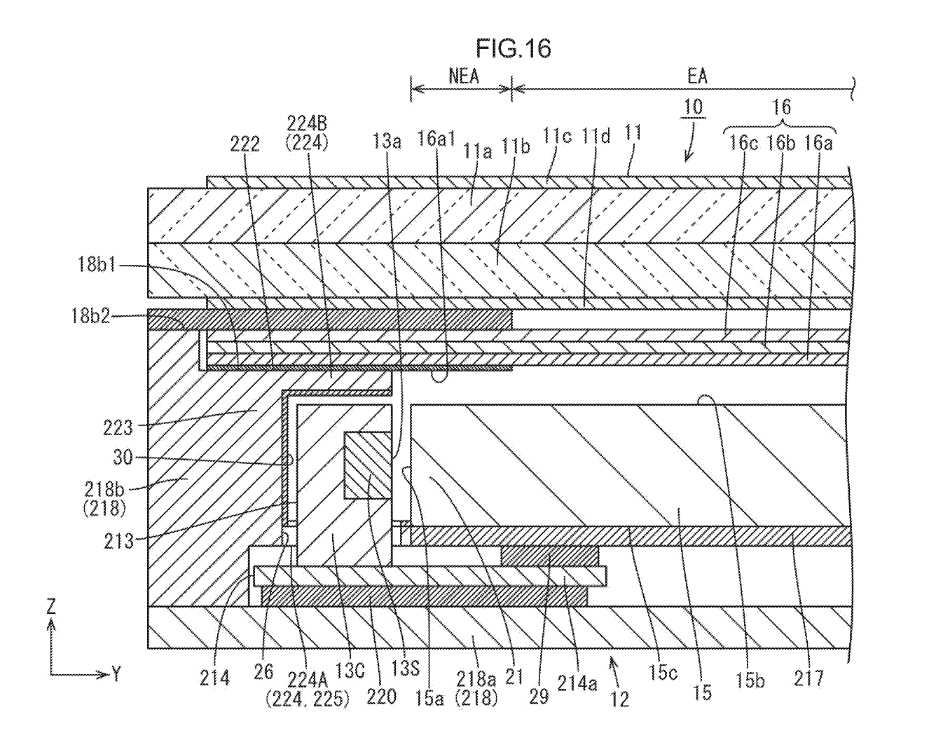

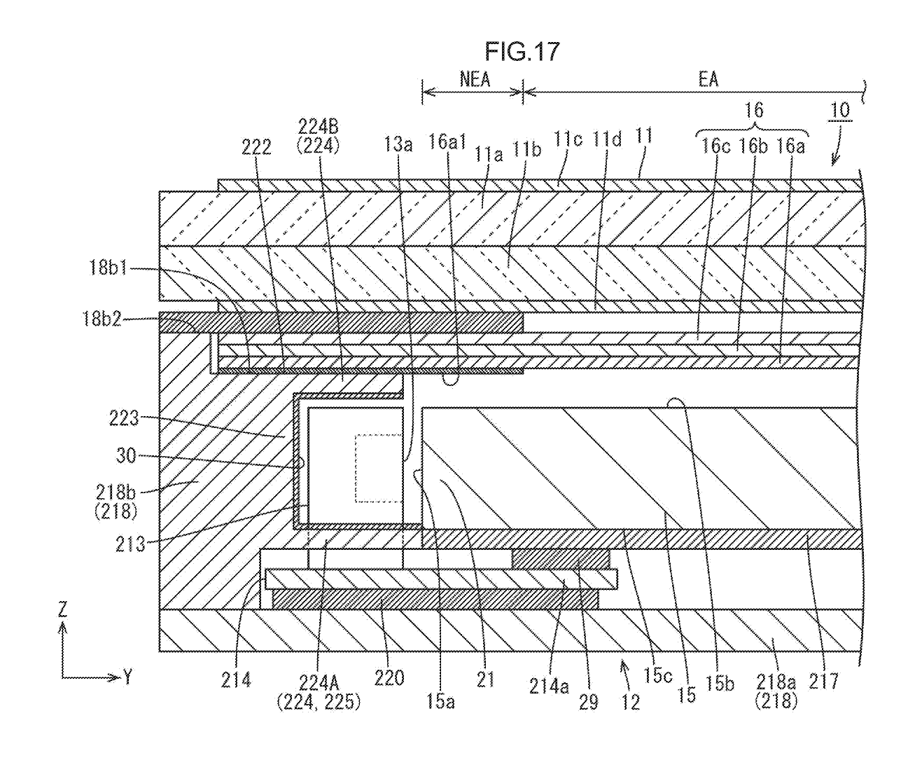

A third embodiment of the present invention will be described with reference to FIGS. 16 to 18. The third embodiment includes a hood-shaped reflection member 222 that is integrated with a component different from that of the first embodiment. Configuration, functions, and effects similar to those of the first embodiment will not be described.

As illustrated in FIG. 16, a casing 218 in this embodiment includes a bottom member 218a (a board holding member) and a side member 218b that are assembled together, that is, has a two-part structure. The hood-shaped reflection member 222 is integrated with the side member 218b of the casing 218. A backside second reflection portion 224A of the hood-shaped reflection member 222 is disposed on the front side relative to an LED board 214, that is, on an LED 213 mounting side of the LED board 214 to overlap the LED board 214. The backside second reflection portion 224A is defined as an LED board overlapping portion 225. The bottom member 218a of the casing 218 is disposed such that the LED board 214 is sandwiched between the LED board overlapping portion 225 and the bottom member 218a to hold the LED board 214. A second board fixing member 29 is disposed between a light guide plate overlapping portion 214a of the LED board 214 and a reflection sheet 217. The second board fixing member 29 is a double-sided adhesive including a base with front and back surfaces to which an adhesive is applied similar to a board fixing member 220. The second board fixing member 29 fixes the LED board 214 to the reflection sheet 217.

As described above, the hood-shaped reflection member 222 is integrated with the side member 218b of the casing 218 and made of synthetic resin that is the same as the material of the side member 218b. Reflection films 30 are formed on a first reflection portion 223 and a pair of second reflection portions 224 (the backside second reflection portion 224A and a front-side second reflection portion 224B) of the hood-shaped reflection member 222, respectively. The reflection films 30 are thin films made of metal material (e.g., silver and aluminum). Light reflectivity at surfaces of the reflection films 30 is higher than light reflectivity at a surface of the hood-shaped reflection member 222. It is preferable that the reflection films 30 are formed on the surfaces of the first reflection portion 223 and the second reflection portions 224 through evaporation coating. In such a configuration in which the hood-shaped reflection member 222 is made of synthetic resin, a sufficient level of the light reflectivity may not be achieved at the surface of the hood-shaped reflection member 222. By forming the reflection films 30 on the first reflection portion 223 and the second reflection portions 224, the hood-shaped reflection member 222 is provided with the sufficiently level of the light reflectivity.

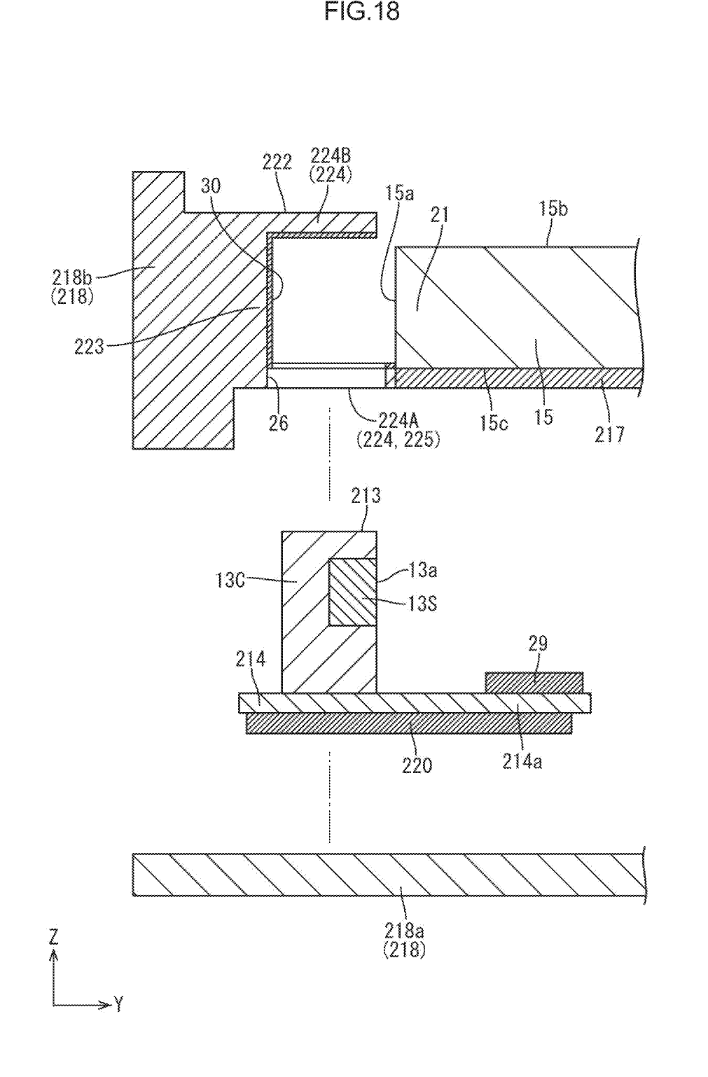

To mount the hood-shaped reflection member 222 that is integrated with the side member 218b of the casing 218 to the LED board 214, as illustrated in FIG. 18, the hood-shaped reflection member 222 is placed on the front side relative to the LED board 214 and brought closer to the LED board 214 until the LEDs 213 are inserted into LED insertion through holes 226, respectively. As illustrated in FIG. 16, the backside second reflection portion 224A of the hood-shaped reflection member 222 is disposed on the front side relative to the LED board 214 to overlaps the LED board 214. The second board fixing member 29 is fixed to the reflection sheet 217. Then, the bottom member 218a is mounted to the side member 218b and the LED board 214. The LED board 214 is sandwiched between the bottom member 218a and the LED board overlapping portion 225 and held. The board fixing member 220 is fixed to the bottom, member 218a.

As described above, in this embodiment, the hood-shaped reflection member 222 is made of synthetic resin and the reflection films 30 are formed on the first reflection portion 223 and the second reflection portions 224 of the hood-shaped reflection member 222, respectively. In such a configuration in which the hood-shaped reflection member 222 is made of synthetic resin, the sufficient level of the light reflectivity may not be achieved at the surface of the hood-shaped reflection member 222. By forming the reflection films 30 on the first reflection portion 223 and the second reflection portions 224, the hood-shaped reflection member 222 can be provided with the sufficient level of the light reflectivity.

This embodiment includes the bottom member 218a (the board holding member) disposed such that the LED board 214 is sandwiched between the LED board overlapping portion 225 and the bottom member 218a. With the bottom member 218a, the LED board 214 can be hold.

### Fourth Embodiment

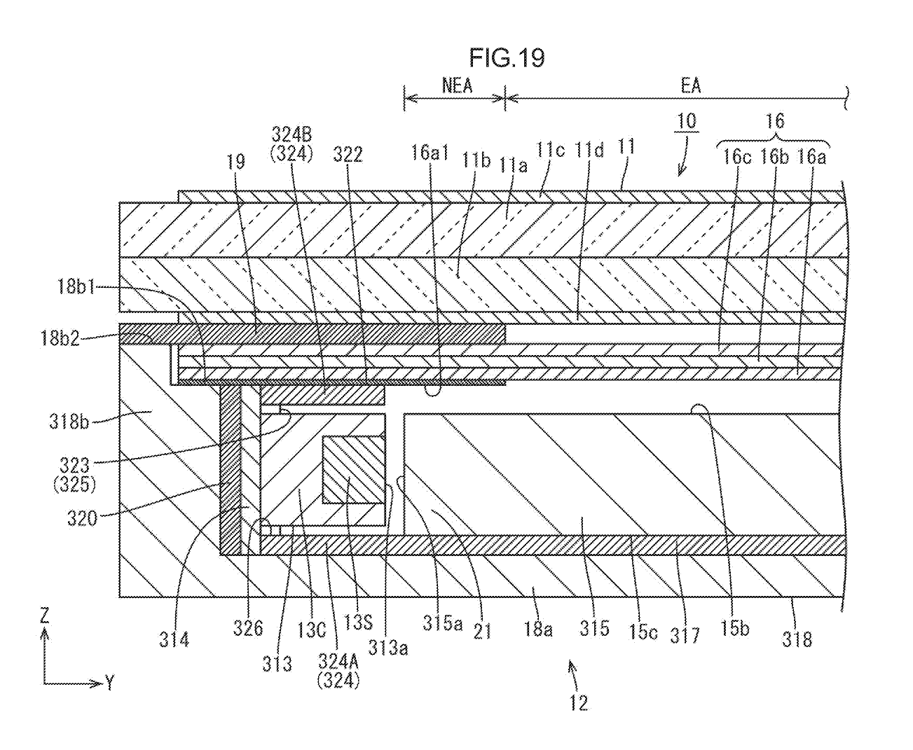

A fourth embodiment of the present invention will be described with reference to FIGS. 19 to 21. The fourth embodiment includes LEDs 313 mounted on an LED board 314 differently from those of the first embodiment and a hood-shaped reflection member 322 having a configuration different from that of the first embodiment. Configuration, functions, and effects similar to those of the first embodiment will not be described.

As illustrated in FIG. 19, the LEDs 313 in this embodiment include surfaces on an opposite side from mounting surfaces fixed to the LED board 314. The surfaces are configured as light emitting surfaces 313a. Namely, the LEDs 313 are top emitting-type LEDs. The LED board 314 includes plate surfaces parallel to the X-axis direction and the Z-axis direction (a light emitting end surface 315a). A mounting surface of the LED board 314 on which the LEDs 313 are mounted is opposed to a light entering end surface 315a of a light guide plate 315. The LEDs 313 are disposed between the LED board 314 and the light guide plate 315 with respect to the Y-axis direction. The LED board 314 is fixed to a side member 318b of a casing 318 with the board fixing member 320.

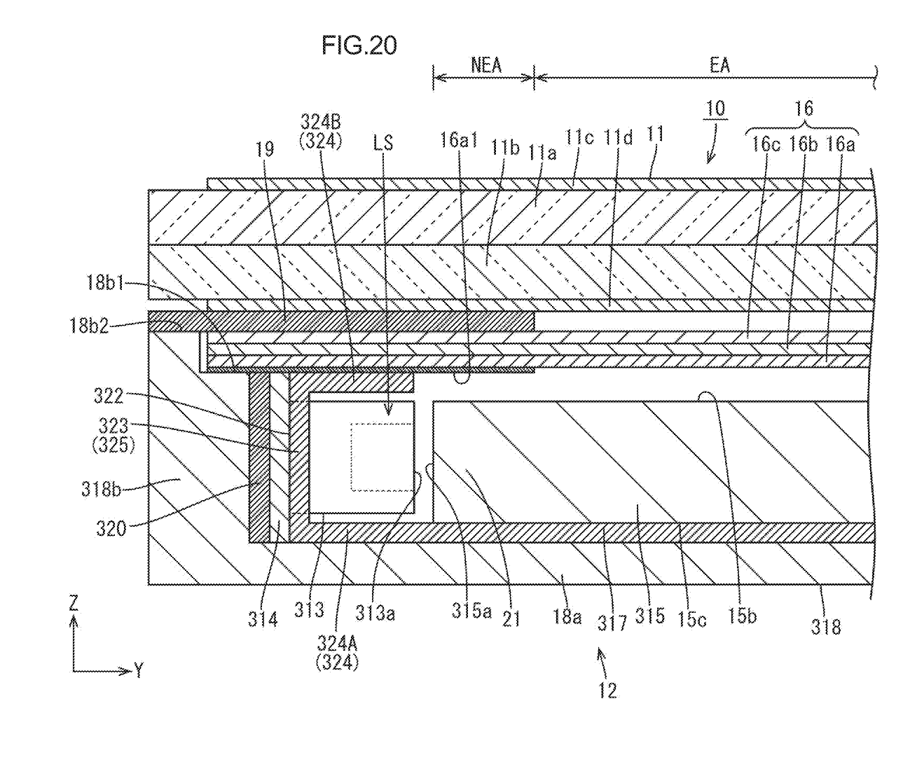

As illustrated, in FIGS. 19 and 20, a first reflection portion 323 among the first reflection portion 323 and second reflection portions 324 (a backside second reflection portion 324A and a front-side second reflection portion 324B) of the hood-shaped reflection member 322 that is integrated with a reflection sheet 317 is disposed on the light guide plate 315 side, that is, on the LED 313 mounting side relative to the LED board 314. In this embodiment, the first reflection portion 323 is configured as an LED board overlapping portion 325. The first reflection portion 323, which is the LED board overlapping portion 325, includes LED insertion through holes in which the LEDs 313 are inserted. The backside second reflection portion 324A does not include the LED insertion through holes 326.

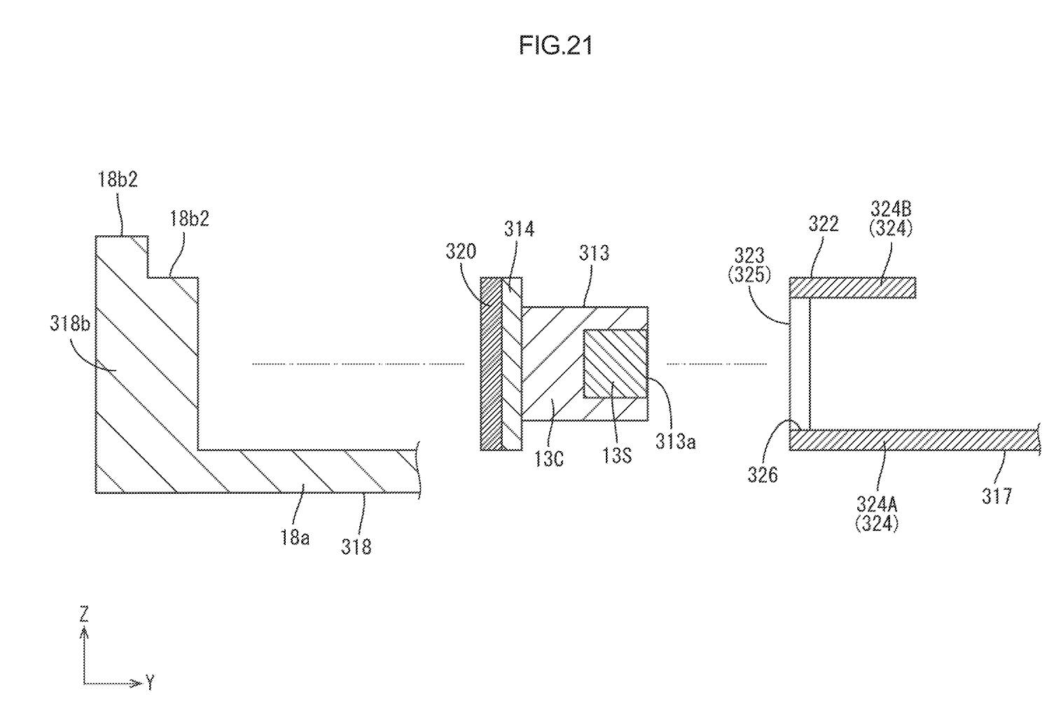

To mounting the hood-shaped reflection member 322 that is integrated with the reflection sheet 317 to the LED board 314, as illustrated in FIG. 21, the hood-shaped reflection member 322 is placed on an inner side (a light guide plate 315 side) relative to the LED board 314 that is fixed to the side member 318b of the casing 318 and brought closer to the LED board 314 until the LEDs 313 are inserted into the respective LED insertion through holes 326. As illustrated in FIGS. 19 and 20, the first reflection portion 323 of the hood-shaped reflection member 322 is disposed on the inner side relative to the LED board 314 to overlap the LED board 314.

As described above, in this embodiment, the LED board overlapping portion 325 of the hood-shaped reflection member 322 is configured as the first reflection portion 323. This configuration is preferable when the LED board 314 on which the top emitting-type LEDs 313 are mounted is used.

### Fifth Embodiment

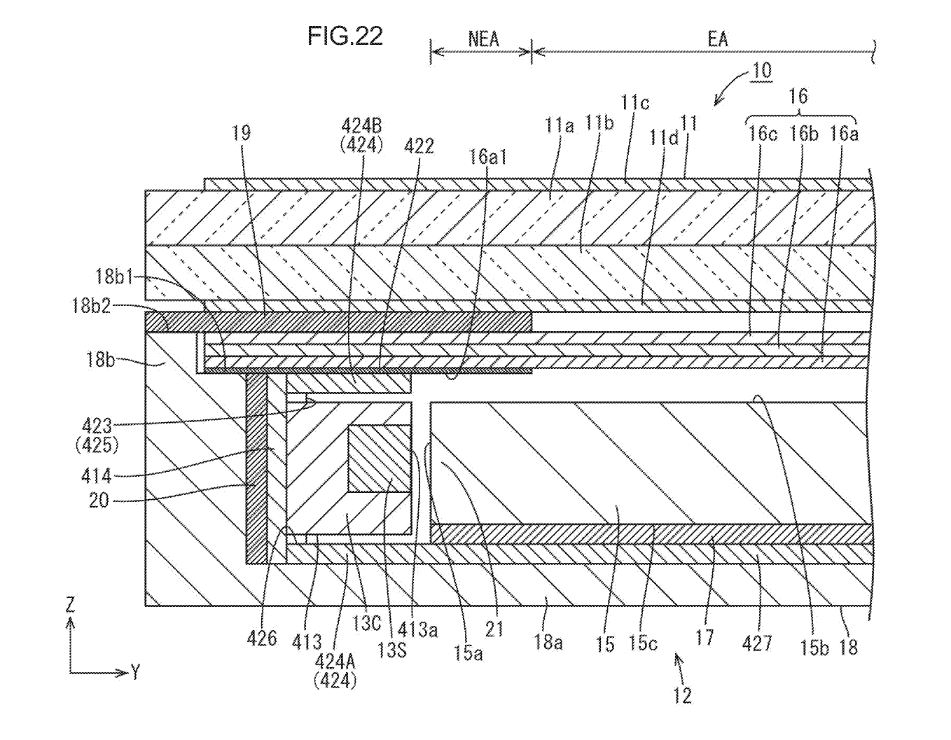

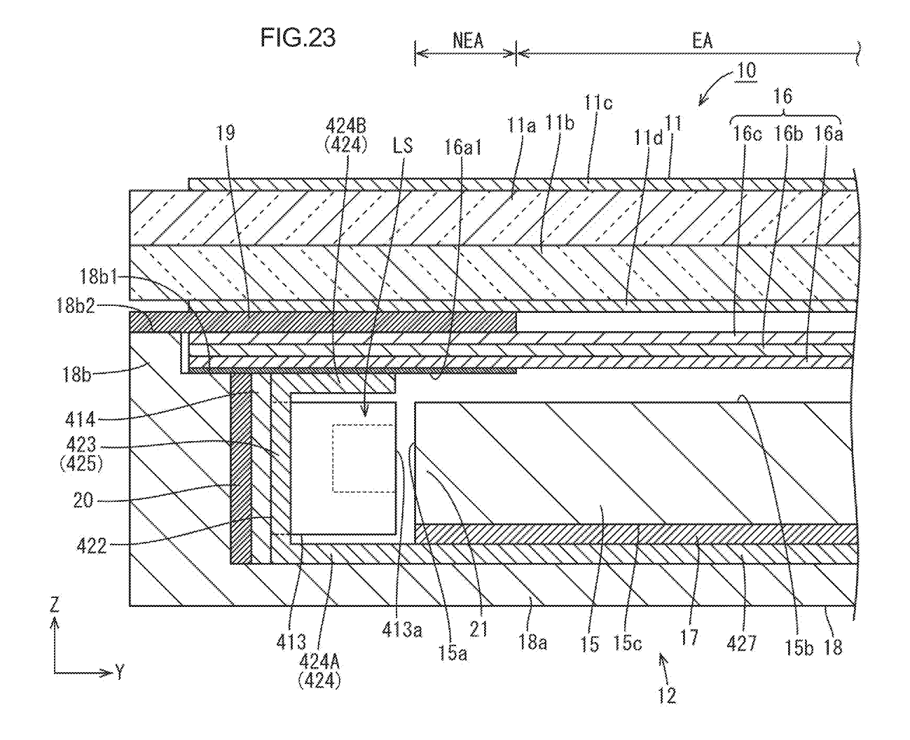

A fifth embodiment of the present invention will be described with reference to FIGS. 22 and 23. The fifth embodiment includes LEDs 413 mounted on an LED board 414 differently from those of the second embodiment and a hood-shaped reflection member 422 having the same configuration as that of the fourth embodiment. Configuration, functions, and effects similar to those of the second and the fourth embodiments will not be described.

As illustrated in FIG. 22, the LEDs 413 in this embodiment include light emitting surfaces 413a on an opposite side from mounting surfaces that are fixed to the LED board 414, similar to those in the fourth embodiment. Namely, the LEDs 413 are top emitting-type LEDs. A first reflection portion 423 among the first reflection portion 423 and a pair of second reflection portions 424 (a backside second reflection portion 424A and a front-side second reflection portion 424B) of the hood-shaped reflection member 422 that is integrated with a holding member 427 is configured as an LED board overlapping portion 425 that overlaps the LED board 414 as illustrated in FIGS. 22 and 23. The first reflection portion 423 that is the LED board overlapping portion 425 includes LED insertion through holes 426 in which the LEDs 413 are inserted.

### Sixth Embodiment

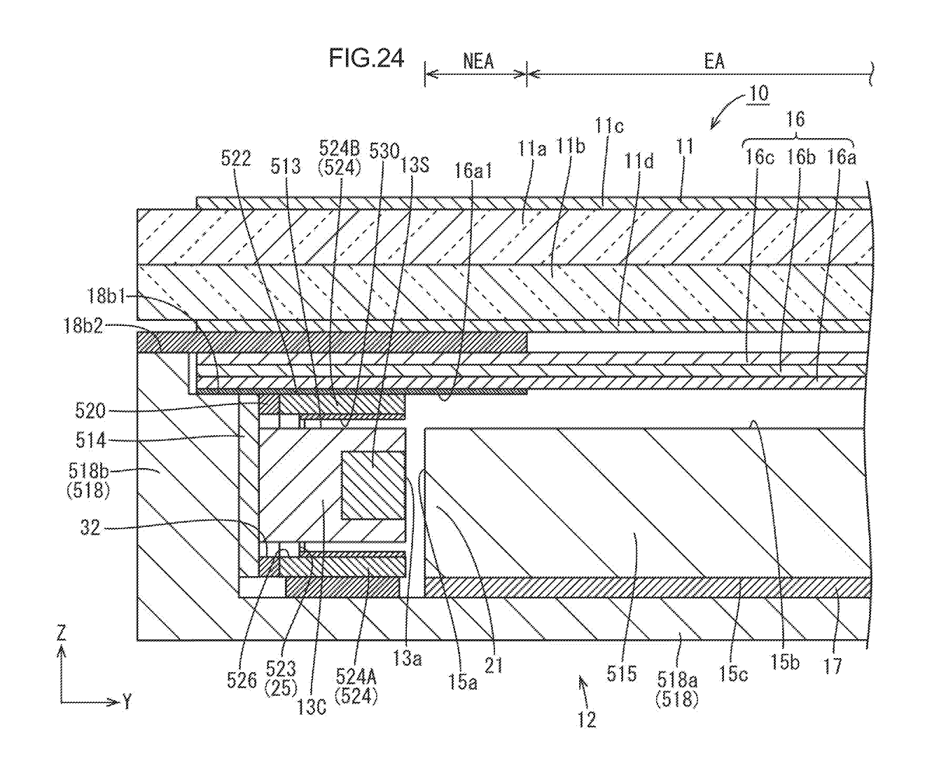

A sixth embodiment of the present invention will be described with reference to FIGS. 24 to 26. The sixth embodiment has a configuration similar to that of the third embodiment but LEDs 513 are mounted on an LED board 514 similarly to those of the fourth embodiment and a hood-shaped reflection member 522 has a different configuration. Configuration, functions, and effects similar to those of the third and the fourth embodiments will not be described.

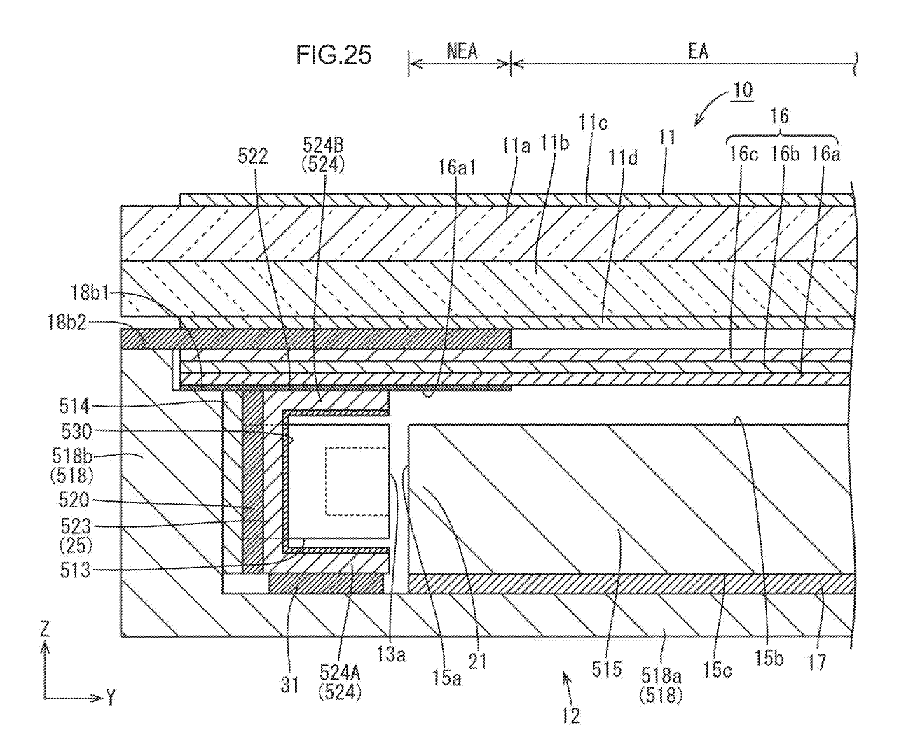

As illustrated in FIG. 25, the LEDs 513 in this embodiment are the top emitting-type LEDs including the surfaces on the opposite side from the mounting surfaces fixed to the LED board 514 are configured as light emitting surfaces 513a, similar to those in the fourth embodiment. The hood-shaped reflection member 522 is made of the same material as a casing 518; however, the hood-shaped reflection member 522 is formed as a separate component from a bottom member 518a and a side member 518b of the casing 518 and fixed to the bottom member 518a with a hood-shaped reflection member fixing member 31. The hood-shaped reflection member fixing member 31 is a double-sided adhesive including a base with front and back surfaces to which an adhesive is applied, similar to a board fixing member 520. Reflection films 530 are formed on a first reflection portion 523 and the pair of second reflection portions 524 (a backside second reflection portion 524A and a front-side second reflection portion 524B), respectively. With the reflection films 530, a sufficient level of light reflective performance can be achieved. The LED board 514 is fixed to an outer surface of the first reflection portion 523 of the hood-shaped reflection member 522 with the board fixing member 520. The board fixing member 520 includes LED insertion through holes 32 in which the LEDs 513 are inserted.

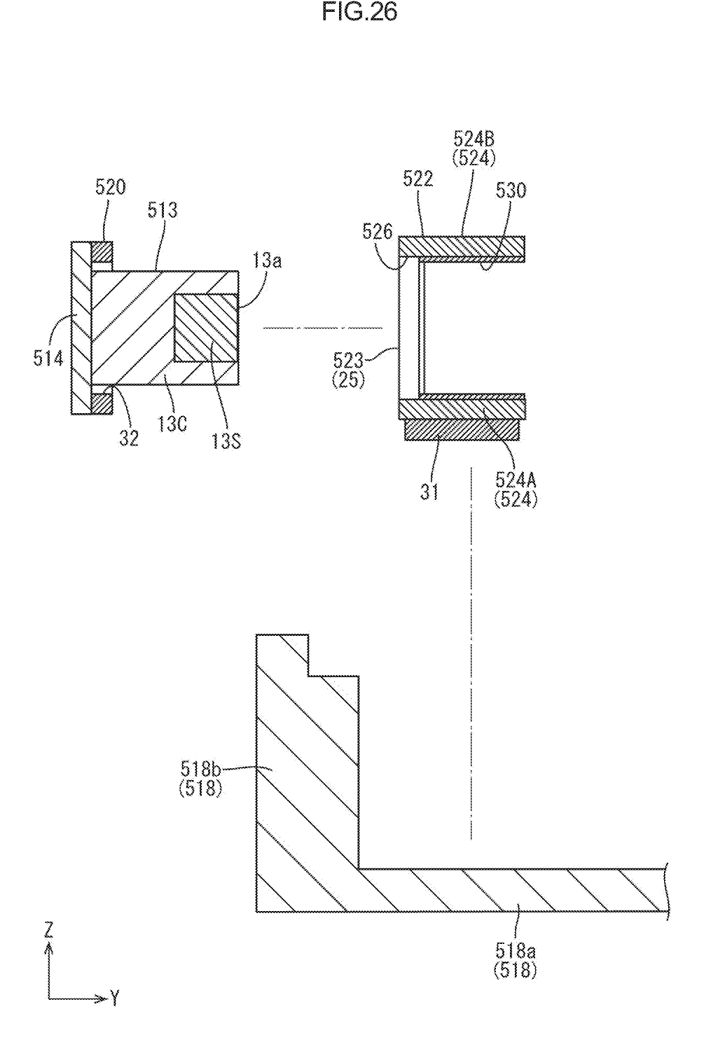

To mounting the hood-shaped reflection member 522 to the LED board 514, as illustrated in FIG. 26, the hood-shaped reflection member 522 is placed on an inner side (a light guide plate 515 side) relative to the LED board 514 with respect to the Y-axis direction and brought closer to the LED board 514 until the LEDs 513 are inserted into the respective LED insertion through holes 526. As illustrated in FIG. 24, the first reflection portion 523 of the hood-shaped reflection member 522 is disposed on the inner side relative to the LED board 514 to overlap the LED board 514. The LED board 514 is fixed to the first reflection portion 523 with the board fixing member 520. The hood-shaped reflection member 522 to which the LED board 514 is mounted is mounted to the bottom member 518a of the casing 518. The hood-shaped reflection member 522 is fixed to the bottom member 518a with the hood-shaped reflection member fixing member 31.

### Seventh Embodiment

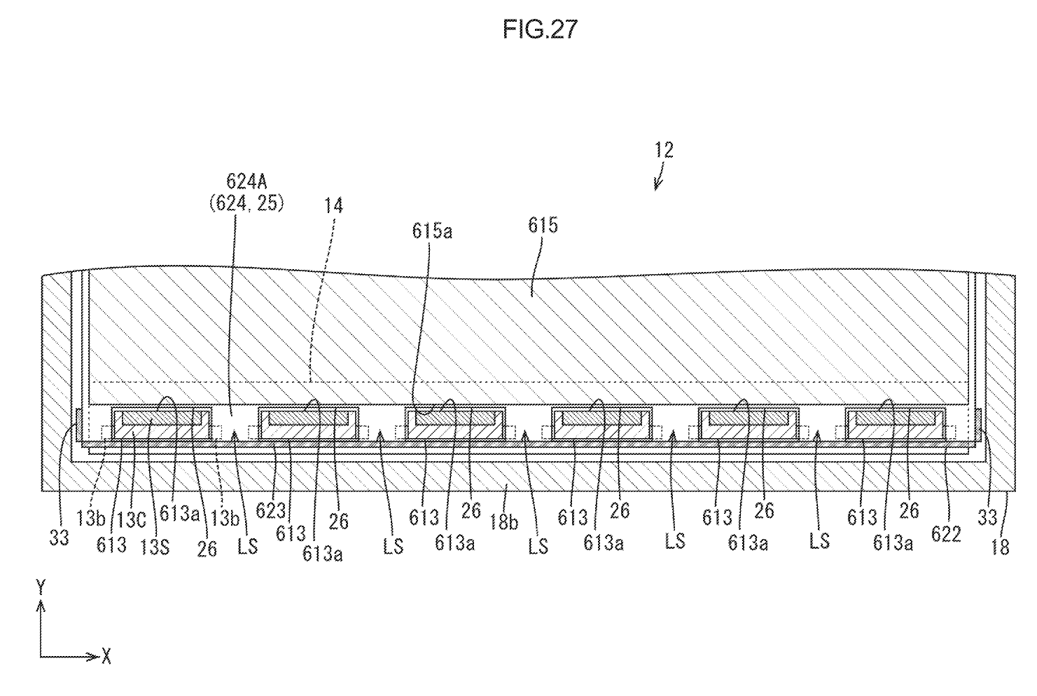

A seventh embodiment of the present invention will be described with reference to FIG. 27. The seventh embodiment includes a hood-shaped reflection member 622 having a configuration different from that of the first embodiment. Configuration, functions, and effects similar to those of the first embodiment will not be described.

As illustrated in FIG. 27, the hood-shaped reflection member 622 in this embodiment includes a first reflection portion 623, a pair of second reflection portions 624 (a backside second reflection portion 624A and a front-side second reflection portion), and a pair of side reflection portions 33. The side reflection portions 33 are disposed to cover LEDs 613 at ends with respect to the X-axis direction (an arrangement direction of the LEDs 613) from outer sides, respectively. The side reflection portions 33 extend from the first reflection portion 623 to a plane on which light emitting surfaces 613a of the LEDs 613 are located with respect to the Y-axis direction, similar to the front second reflection portion). According to the configuration, light rays emitted by the LEDs 613 at the ends with respect to the X-axis direction and traveling outward along the X-axis direction are reflected by the side reflection portions 33 and the reflected light rays are directed to a light entering end surface 615a of a light guide plate 615. Because the light rays are less likely to leak to the outside with respect to the X-axis direction, high light use efficiency can be achieved.

As described above, the hood-shaped reflection member 622 in this embodiment includes the side reflection portions 33 that cover the LEDs 613 at the ends with respect to the arrangement direction of the LEDs 613 from the outer sides with respect to the arrangement direction. According to the configuration, the light rays emitted by the LEDs 613 at the ends of the arrangement direction are reflected by the side reflection portions 33 and directed to the light entering end surface 615a. Because the light rays are less likely to leak to the outside with respect to the arrangement direction, high light use efficiency can be achieved.

### Eighth Embodiment

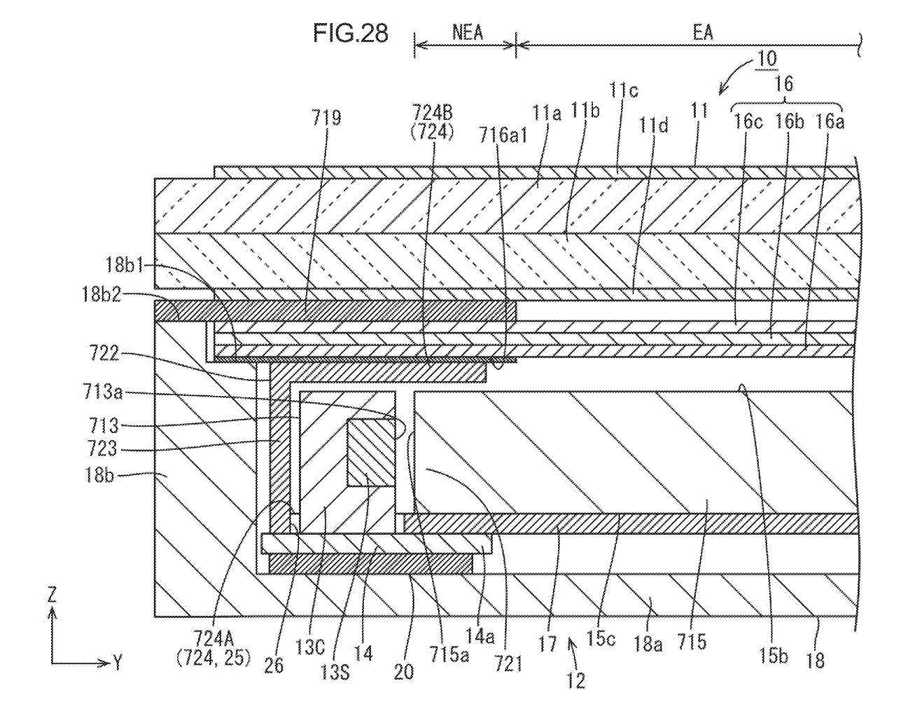

An eighth embodiment of the present invention will be described with reference to FIG. 28. The eighth embodiment includes a hood-shaped reflection member 722 having a configuration different from that of the first embodiment. Configuration, functions, and effects similar to those of the first embodiment will not be described.

As illustrated in FIG. 28, a front-side second reflection portion 724B of a pair of second reflection portions 724 (a backside second reflection portion 724A and the front-side second reflection portion 724B) of the hood-shaped reflection member 722 in this embodiment extends in the Y-axis direction to a position to overlap the a light entering-side edge section 721 of a light guide plate 715. The front-side second reflection portion 724B is disposed to cover a space between light emitting surfaces of LEDs 713 and a light entering end surface 715a of the light guide plate 715 from the front side and the light entering-side edge section 721 from the front side. According to the configuration, light rays traveling from the space between light emitting surfaces 713a of the LEDs 713 and the light entering end surface 715a of the light guide plate 715 to the front side are reflected by the front-side second reflection portion 724B and efficiently directed to the light entering end surface 715a. Therefore, high light use efficiency can be achieved. The front-side second reflection portion 724B is disposed such that an inner edge (an edge on an opposite side from a first reflection portion 723) is located closer to the outer side in comparison to inner edges of a panel fixing member 719 and a light blocking layer 716a1. Therefore, the front-side second reflection portion 724B is less likely to be directly viewed by a user.

### Other Embodiments

The present invention is not limited to the embodiments, which have been described using the foregoing descriptions and the drawings. For example, embodiments described below are also included in the technical scope of the present invention.

(1) In each of the above embodiments, the hood-shaped reflection member is disposed to collectively surround the inter-LED spaces and the LEDs. However, the number of the inter-LED spaces and the number of LEDs surrounded by the hood-shaped reflection member may be altered where appropriate as long as at least one of the inter-LED spaces is surrounded by the hood-shaped reflection member. Alternatively, only the inter-LED spaces may be surrounded by the hood-shaped reflection member and the LEDs may not be surrounded by the hood-shaped reflection member.

(2) In the first embodiment, the hood-shaped reflection member is formed after the LEDs are inserted in the respective LED insertion through holes in the reflection sheet that is in the state before the hood-shaped reflection member is formed. However, the hood-shaped reflection member may be formed in advance and then the LEDs may be inserted in the respective LED insertion through holes.

(3) In each of the second and the fifth embodiments, the hood-shaped is integrated with the holding member. However, the main portion of the holding member which covers the back side of the reflection sheet may be removed and only the hood-shaped reflection member may be provided.

(4) In each of the second and the fifth embodiments, the holding member with which the hood-shaped reflection member is integrated is made of metal. However, the holding member with which the hood-shaped reflection member is integrated may be made of synthetic resin. In this case, it is preferable that a reflection film is disposed on the inner surface of the hood-shaped reflection member similar to the third embodiment.

(5) In each of the second and the fifth embodiments, the terminals of the LEDs are not inserted in the LED insertion through holes. However, the terminals of the LEDs may be inserted in the LED insertion through holes. In this case, it is preferable that insulators are disposed in areas of the backside second reflection portion of the hood-shaped reflection member around the terminals.

(6) In each of the third and the sixth embodiments, the side portions and the bottom portion of the casing with which the hood-shaped reflection member is integrated are made of synthetic resin. However, the side portions and the bottom portion of the casing with which the hood-shaped reflection member may be made of metal. Alternatively, the hood-shaped reflection member and the side portions may be made of metal and the bottom portion may be made of synthetic resin or the hood-shaped reflection member and the side portions may be made of synthetic resin and the bottom portion may be made of metal. If at least the hood-shaped reflection member and the side portions are made of synthetic resin, it is preferable that a reflection film is disposed on the inner surface of the hood-shaped reflection member. If at least the hood-shaped reflection member and the side portions are made of metal, it is preferable that insulators are disposed on the hood-shaped reflection member.

(7) In each of the third and the sixth embodiments, the hood-shaped reflection member is integrated with the side portion of the casing. However, the hood-shaped reflection member may be integrated with the bottom portion of the casing. In this case, the side portions may be formed separately from the bottom portion and the hood-shaped reflection member and integrated with the bottom portion through assembly.

(8) In each, of the third and the sixth embodiments, the reflection, film is made of metal. However, a material other than metal may be used.

(9) In the sixth embodiment, the hood-shaped reflection member and the casing are made of the same material. However, the hood-shaped reflection member and the casing may be made of different materials. In this case, the hood-shaped reflection member and the reflection sheet may be made of the same material or the hood-shaped reflection member and the holding member may be made of the same material.

(10) In the seventh embodiment, inner end surfaces of the side reflection portions are on the plane on which the light emitting surfaces of the LEDs are located. However, the side reflection portions may be disposed to overlap the light entering-side section of the light guide plate similar to the front-side second reflection portion in the eighth embodiment.

(11) The area of the front-side second reflection portion overlapping the light guide plate is not limited to that in the eighth embodiment and may be altered where appropriate. The front-side second reflection portion may not overlap the light guide plate. In this case, the area of the front-side second reflection portion overlapping the space between the light emitting surfaces of the LEDs and the light entering end surface of the light guide plate may be altered where appropriate.

(12) The features in above (11) can be applied to the side reflection portions in the seventh embodiment.

(13) In each of the above embodiments, the terminals of the LEDs are connected to the wiring pattern on the LED board through soldering. However, the terminals may be connected to the trace through a process other than the soldering.

(14) The number of the LEDs or intervals of the LEDs mounted on the LED board (a size of the inter-LED spaces) may be altered from, those in each of the above embodiments where appropriate.

(15) In each of the above embodiments, one of the short end surfaces of the light guide plate is configured as the light entering end surface. However, one of the long end surfaces of the light guide plate may be configured as a light entering end surface. Other than that, both of the short end surfaces or both of the long end surfaces of the light guide may be configured as light entering end surfaces. Alternatively, any three of the end surfaces of the light guide plate may be configured as light entering end surfaces or all of the end surfaces of the light guide plate may be configured as light entering end surfaces.

(16) In each of the above embodiments, the light guide plate has the rectangular two-dimensional shape. However, the light guide plate may have a circular two-dimensional shape or an oval two-dimensional shape. In this case, the LEDs may be circularly disposed along an outline of the light guide plate.

(17) In each of the above embodiments, the LED board includes the base board that is in the form of film. However, the base board of the LED board may be in a form of plate having a certain thickness.

(18) In each of the above embodiments, the LED board includes the LEDs mounted on the base board. However, the present invention can be applied to light source boards including other types of light sources such as organic ELs.

(19) The liquid crystal display device in each of the above embodiments is for a portable information terminals such as a smartphone and a tablet-type laptop personal computers. However, the present invention can be applied to a liquid crystal display device for onboard information terminals (portable car navigation systems), portable video game players, or smartwatches.

(20) In each of the above embodiments, the color filters in the liquid crystal panel include three color portions of R, G, and B. However, the color filters may include four or more colors of color portions.

(21) In each of the above embodiments, the TFTs are used as the switching components of the liquid crystal panel. However, the present invention may be applied to a liquid crystal panel that includes switching components other than TFTs (e.g., thin film diodes (TFD)). The present invention may be applied to a liquid crystal panel that is configured to display black-and-white images other than the liquid crystal panel that is configured to display color images and a method of producing the liquid crystal panel.

(22) In each of the above embodiments, the liquid crystal display device includes the backlight unit and the liquid crystal panel. However, the present invention may be applied to a micro electro mechanical systems (MEMS) display device including a backlight unit and a MEMS display panel.

### EXPLANATION OF SYMBOLS

10: Liquid crystal display device (Display device)

11: Liquid crystal panel (Display panel)

12, 112: Backlight unit (Lighting device)

13, 113, 213, 313, 413, 513, 613, 713: LED (Light source)

13a, 313a, 413a, 613a, 713a: Light emitting surface

13b, 113b: Terminal

14, 114, 214, 314, 414, 514: LED board (Light source board)

15, 115, 315, 515, 615, 715: Light guide plate

15a, 315a, 615a, 715a: Light entering end surface

15b, 115b: Light exiting plate surface

15c, 115c: Opposite plate surface

17, 117, 217, 317: Reflection sheet (Light guide plate reflection member)

22, 122, 222, 322, 422, 522, 622, 722: Hood-shaped reflection member

23, 123, 223, 323, 423, 523, 623, 723: First reflection portion

24, 124, 224, 324, 424, 524, 624, 724: Second reflection portion

25, 225, 325, 425: LED board overlapping portion (Light source board overlapping portion)

26, 126, 326, 426, 526: LED insertion through hole (Light source insertion through hole)

27, 427: Holding member

28: Insulator

30, 530: Reflection film

33: Side reflection portion

218a: Bottom portion (Board holding member)

LS: Inter-LED space (Inter-light source space)

1. A lighting device comprising:
a plurality of light sources linearly arranged at intervals;
a light guide plate having a flat plate shape, the light guide plate including:
a light entering end surface extending along an arrangement direction of the light sources, the light entering end surface being at least a part of a peripheral end surface of the light guide plate opposed to light emitting surfaces of the light sources; and
a light exiting plate surface through which light rays exit, the light exiting plate surface being one of plate surfaces of the light guide plate; and
a hood-shaped reflection member surrounding at least an inter-light source space between the adjacent light sources and including an opening on a light guide plate side, the hood-shaped reflection member including at least:
a first reflection portion opposed to the light entering end surface; and
a pair of second reflection portions continuous from the first reflection portion to be separated from each other in a thickness direction of the light guide plate such that the inter-light source space is between the second reflection portions.

2. The lighting device according to claim 1, wherein the first reflection portion and the second reflection portions of the hood-shaped reflection member extend along the arrangement direction of the light sources to be opposed to at least one of the light sources.

3. The lighting device according to claim 2, wherein the first reflection portion and the second reflection portions of the hood-shaped reflection member extend along the arrangement direction of the light sources to be opposed to all the light sources.

4. The lighting device according to claim 1, wherein one of the second reflection portions of the hood-shaped reflection member disposed on a light exiting plate surface side relative to the inter-light source space with respect to the thickness direction is located on a plane on which the light emitting surfaces of the light sources are located.

5. The lighting device according to claim 1, further comprising a light source board on which the plurality of light sources are mounted, wherein
the hood-shaped reflection member includes a light source board overlapping portion disposed to overlap the light source board on a mounting side on which the light sources are mounted and configured as any one of the first reflection portion and the second reflection portions, and
the light source board overlapping portion includes a plurality of light source insertion through holes in which the light sources are inserted.

6. The lighting device according to claim 5, wherein
the light sources include terminals connected to the light source board, respectively, and
the hood-shaped reflection member is made of metal having conductivity and includes insulators on a surface opposed to the light source board at positions overlapping the terminals.

7. The lighting device according to claim 5, wherein the light source board overlapping portion of the hood-shaped reflection member is configured as any one of the second reflection portions.

8. The lighting device according to claim 5, wherein the light source board overlapping portion of the hood-shaped reflection member is configured as the first reflection portion.

9. The lighting device according to claim 5, further comprising a board holding member disposed such that the light source board is sandwiched between the light source board overlapping portion and the board holding member.

10. The lighting device according to claim 1, further comprising a light guide plate reflection member disposed to overlap an opposite plate surface of the light guide plate on an opposite side from the light exiling plate surface and configured to reflect the light rays, wherein
the hood-shaped reflection member is integrated with the light guide plate reflection member.

11. The lighting device according to claim 1, further comprising:
a light guide plate reflection member disposed to overlap an opposite plate surface of the light guide plate on an opposite side from the light exiting plate surface and configured to reflect the light rays; and
a holding member disposed to overlap the light guide plate reflection member on an opposite side from the light guide plate side to sandwich the light guide plate reflection member with the light guide plate, wherein
the hood-shaped reflection member is integrated with the holding member.

12. The lighting device according to claim 1, wherein
the hood-shaped reflection member is made of synthetic resin, and
reflection films are formed on the first reflection portion and the second reflection portions of the hood-shaped reflection member, respectively.

13. The lighting device according to claim 1, wherein the hood-shaped reflection member includes a pair of side reflection portions covering the light sources at ends with respect to the arrangement direction of the light sources from outer sides with respect to the arrangement direction, respectively.

14. A display device comprising:
the lighting device according to claim 1; and
a display panel configured to display images using light applied by the lighting device.
